(19) United States
(12) Patent Application Publication
(10) Pub. No.: US 2002/0096468 A1
(43) Pub. Date: Jul. 25, 2002

(54) Disposable vacuum filtration apparatus capable of detecting microorganisms and particulates in liquid samples

(76) Inventor: Peter Zuk JR., Harvard, MA (US)

Correspondence Address: Peter Zuk Jr., 258 Old Littleton Rd., Harvard, MA, 01451, US

(21) Appl. No.: 10/005,856

(22) Filed: Dec. 4, 2001

Related U.S. Application Data
(60) Provisional application No. 60/251,130, filed on Dec. 4, 2000.
(60) Provisional application No. 60/297,832, filed on Jun. 12, 2001.

(51) Int. Cl. B01D 35/00

(52) U.S. Cl. 210/455; 210/479

(57) ABSTRACT

A vacuum filtration apparatus (100) for detecting microorganisms and particulates in liquid samples. The apparatus includes a base (1), an absorbent pad (91), a filter means (90), a funnel (30), and a lid (60). The funnel contains an integral flexible seal for releasably attaching the funnel to the base, and an integral flexible seal for releasably sealing the filter means to the base. The base and funnel contain one or more lid clamp tabs. The outer wall of the lid is segmented to make it flexible, this flexibility allows it to be releasably attached to the lid clamp tabs of either the funnel or the base. The flexible seals and segmented lid allow any funnel to fit to any base, and any lid to fit to any base or to any funnel when all parts are manufactured to normal tolerances. The apparatus contains a means to keep the filter means wrinkle free in both the dry and wet states.

### BACKGROUND OF THE INVENTION

This invention relates to the filtration field, and more particularly, to an improved disposable vacuum filtration apparatus capable of detecting microorganisms and particulates in liquid samples. There are commercially available disposable vacuum filtration devices for detecting microorganisms and particulates in liquid samples available today. The currently available disposable vacuum filtration devices for detecting microorganisms and particulates in liquid samples contain a base section, a removable funnel section, and a removable lid. An absorbent pad, and microporous filter are inserted into the base section. The absorbent pad is placed into a well in the base section, and the microporous filter (normally of larger diameter than the absorbent pad) is inserted above the absorbent pad (i.e. on the upstream side of the absorbent pad). The absorbent pad provides support for the microporous filter. The base section also contains a filter support means which provides support for the absorbent pad and provides fluid flow communication between the downstream side of the absorbent pad and an outlet port located at the bottom of the base section. The removable funnel section is press fitted or snapped into the base section. The outer periphery of the microporous filter is either sealed to the base section or sealed between the bottom edge of the funnel section and the base section. The removable lid is press fitted onto the top of the removable funnel section preferably with a fit that allows easy removal, but that does not allow the lid to accidentally separate from the funnel section. These devices are normally sold pre-sterilized. In use the end user preferably removes a sterile vacuum filtration device from its shipping package in a laminar flow hood to prevent contaminating the device. The lid is then removed from the funnel section and a liquid sample to be tested is poured into the funnel section. The lid is then placed back onto the funnel section and the outlet port of the base section is connected to a vacuum means. The vacuum means sucks the liquid through the microporous filter, and through the absorbent pad, and then through the outlet port, into the vacuum means. Either the lid or the funnel section contains a venting means to allow air to replace the liquid in the funnel as vacuum removes the liquid from the funnel. Once all of the liquid sample has been sucked from the vacuum filtration device, the user will remove the vacuum filtration device from the vacuum means, and then remove the lid from the funnel section, and then remove the funnel section from the base section, and then place the lid onto the top of the base section, and then discard the funnel section. The lid should fit onto the top of the base section with a press fit that allows easy removal, but that does not allow the lid to accidentally separate from the base section when the base section is inverted. With the funnel removed, and with the lid attached to the top of the base section, the lid, base section assembly becomes a petri dish. Either the lid or base section should contain a venting means to allow the air in the interior of the base section with the lid attached to communicate with air outside of the base section. The user then adds a quantity of growth media to the outlet port of the base section, so that the absorbent pad becomes saturated with growth media. The outlet port of the base section is then plugged with a plug (normally supplied with the device), and the base section with lid and plug is inverted and placed into an oven to incubate, so that any bacteria that was trapped on the upstream side of the microporous filter will grow into colonies to be counted later.

When it is desired to count particles in a liquid sample (for example glass fragments in a soft drink sample), the above steps of adding growth media, and incubation are not necessary. The particules can be counted on the upstream side of the microporous filter once the liquid sample has been filtered through the microporous filter. The microporous filter may contain a grid on its upstream side as an aid in counting either particles or microorganisms.

The currently available vacuum filtration devices for detecting microorganisms and particulates in liquid samples suffer from the following drawbacks:

a) The base of the funnel section is press fitted to the base section, therefore the outside diameter of the funnel section must match the inside diameter of the base section. This means that the disposable molded parts must be molded to a very high tolerance, which leads to part matching (i.e. funnel sections being individually matched to base sections), high scrap rates, and higher production costs.

b) The lid is press fitted to the top of the funnel section, and to the top of the base section, therefore the outside diameter of the top of the funnel section, and the outside diameter of the top of the base section must match the inside diameter of the lid. Again this means that the disposable molded parts must be molded to a very high tolerance, which leads to part matching (i.e. funnel sections and base sections being individually matched to a lid), high scrap rates, and higher production costs.

c) For different applications different membrane filter types must be used. The different membrane filter types may be of different thickness. Therefore a funnel section, base section matched pair that works with one type of filter may not work with another type of filter.

d) When the membrane filter wets during filtration, it will swell. The currently available devices do not provide expansion room for the membrane filter to expand radially. If the swelling causes the membrane filter to lift away from the absorbent pad, bacteria that is present on the upstream side of the membrane filter in the area that has lifted away from the absorbent pad will not grow when incubated. Therefore, these bacteria will not be detected.

e) If the funnel section fits into the base section so that the funnel section squeezes the membrane filter to tightly between the funnel section and the base section, then the membrane filter will not be able to expand radially when wet, so that the membrane filter may lift away from the absorbent pad. If the swelling causes the membrane filter to lift away from the absorbent pad, bacteria that is present on the upstream side of the membrane filter in the area that has lifted away from the absorbent pad will not grow when incubated. Therefore, these bacteria will not be detected.

f) All of the above limitations of the present art are exasperated when parts are molded from materials such as polypropylene or polyethylene, which are difficult to mold to tight tolerances.

g) In some applications it is necessary to remove the membrane filter from the base section after filtration is complete, and place said membrane filter into another petri dish for incubation. Currently available devices do not provide an easy means to remove the wet membrane filter from the base section.

It is therefore an object of the present invention to provide a disposable vacuum filtration apparatus for detecting microorganisms and particulates in liquid samples that can be assembled from component parts that have been molded to normal tolerances (i.e. all component parts to be molded within a dimensional tolerance range of ±0.004 of an inch or better). Another object of the present invention is to provide a disposable vacuum filtration apparatus for detecting microorganisms and particulates in liquid samples that can use a filter means of varying thickness, while providing a positive seal to prevent the microorganisms from bypassing the filter means. Another object of the present invention is to provide a disposable vacuum filtration apparatus for detecting microorganisms and particulates in liquid samples that provides a means for the wet filter means to expand radially. Another object of the present invention is to provide a disposable vacuum filtration apparatus for detecting microorganisms and particulates in liquid samples that provides a means to keep the downstream side of the filter means in intimate contact with the upstream side of the absorbent pad disposed below it when the filter means and absorbent pad are both dry or both wet. Another object of the present invention is to provide a disposable vacuum filtration apparatus for detecting microorganisms and particulates in liquid samples that can be molded from materials such as polypropylene, or polyethylene, or from a combination of materials such as polypropylene and polystyrene. Another object of the present invention is to provide a disposable vacuum filtration apparatus for detecting microorganisms and particulates in liquid samples wherein the filter means can be sealed to the base in a manner that will prevent bypass of the microorganisms around the filter means. Another object of the present invention is to provide a disposable vacuum filtration apparatus for detecting microorganisms and particulates in liquid samples wherein the filter means can be sealed using a compression seal between the base and the funnel in a manner that will prevent bypass of the microorganisms around the filter means.

### SUMMARY OF THE INVENTION

The foregoing problems of the prior art are solved, and the objects of the present invention are achieved, by use of a disposable vacuum filtration apparatus constructed in accordance with the principles of the present invention. In accordance with the principles of the present invention, the vacuum filtration apparatus for detecting microorganisms and particulates in liquid samples comprises a base, a funnel, and a lid. An integral flexible sealing means is provided between the funnel and base. This integral flexible sealing means allows any funnel that has been molded with a dimensional tolerance range of ±0.004 of an inch to be mated to any base that has been molded with a dimensional tolerance range of ±0.004 of an inch. The funnel contains an integral flexible sealing means for sealing the filter means with a compression seal between the integral flexible sealing means of the funnel and a seal surface of the base, and for allowing the wet filter means to expand radially. The lid contains a flexible clamping means that allows any lid that has been molded within a dimensional tolerance range of ±0.004 of an inch to be mated to any base that has been molded within a dimensional tolerance range of ±0.004 of an inch, and that allows any lid that has been molded within a dimensional tolerance range of 35 0.004 of an inch to be mated to any funnel that has been molded within a dimensional tolerance range of ±0.004 of an inch.

### BRIEF DESCRIPTION OF THE DRAWINGS

These and other objects, features and advantages of the invention will be evident from the following detailed description when read in conjunction with the accompanying drawings in which:

FIG. 1a is an isometric view, having portions thereof removed, of the assembled components that comprise the first embodiment of the prior art, with the components assembled as the user would receive them, ready for filtration;

FIG. 1b is a partial cross-sectional view of a bottom portion of the assembly depicted in FIG. 1a;

FIG. 1c is a partial cross-sectional view of a bottom portion of the assembly depicted in FIG. 1a, in which the component dimensions have changed from those shown in FIG. 1b;

FIG. 2a is an isometric view, having portions thereof removed, of the assembled components that comprise the first embodiment of the prior art, without the funnel section, with the remaining components assembled in the petri dish mode;

FIG. 2b is an isometric view, having portions thereof removed, of the lid of the assembles depicted in FIG. 1a and 2a;

FIG. 3a is an isometric view, having portions thereof removed, of the assembled components that comprise the second embodiment of the prior art, with the components assembled as the user would receive them, ready for filtration;

FIG. 3b is a partial cross-sectional view of a top portion of the assembly depicted in FIG. 3a;

FIG. 3c is a partial cross-sectional view of a bottom portion of the assembly depicted in FIG. 3a;

FIG. 3d is a partial cross-sectional view of a bottom portion of the assembly depicted in FIG. 3a, in which the component dimensions have changed from those shown in FIG. 3c, and in which the microporous filter and the absorbent pad are shown compressed because of a negative pressure being applied to the downstream side of the absorbent pad;

FIG. 4 is an exploded isometric view of the components that comprise the first embodiment of the filtration apparatus, constructed in accordance with the principles of the present invention, usable for detecting microorganisms and particulates in liquid samples;

FIG. 5 is an isometric view, having portions thereof removed, of the base component of the assembly depicted in FIG. 4;

FIG. 6 is a bottom isometric view of the base component of the assembly depicted in FIG. 4;

FIG. 7 is a magnified partial isometric view of the base component of the assembly depicted in FIG. 4, showing a venting means and a means for clamping the lid to the base;

FIG. 8 is an isometric view, having portions thereof removed, of the funnel component of the assembly depicted in FIG. 4;

FIG. 9 is a partial cross-sectional view of a bottom portion of the funnel depicted in FIG. 8;

FIG. 10 is a magnified partial isometric view of the funnel component depicted in FIG. 8, showing a venting means and a means for clamping the lid to the funnel;

FIG. 11 is a bottom isometric view, of the lid component of the assembly depicted in FIG. 4;

FIG. 12 is an isometric view, having portions thereof removed, of the assembled components that comprise the first embodiment of the filtration apparatus, constructed in accordance with the principles of the present invention, usable for detecting microorganisms and particulates in liquid samples;

FIG. 13a is a partial cross-sectional view of a bottom portion of the assembly depicted in FIG. 12, with the sealing elements of the funnel shown in their non-deflected state;

FIG. 13b is a partial cross-sectional view of a bottom portion of the assembly depicted in FIG. 12, with the sealing elements of the funnel shown in their deflected state;

FIG. 14a is a partial cross-sectional view of a top portion of the assembly depicted in FIG. 12, with the sealing elements of the lid shown in their non-deflected state;

FIG. 14b is a partial cross-sectional view of a top portion of the assembly depicted in FIG. 12, with the sealing elements of the lid shown in their deflected state;

FIG. 15a is a cross-sectional view of the assembled components that comprise the first embodiment of the filtration apparatus, constructed in accordance with the principles of the present invention, without the funnel section, with the remaining components assembled in the petri dish mode, with said assembly shown inverted;

FIG. 15b is a magnified partial cross-sectional view of the assembly shown in FIG. 15a, showing the sealing means between the base and lid, and the venting means between the base and lid;

FIG. 16 is a partial cross-sectional view of the bottom portion of a second embodiment of the filtration apparatus, constructed in accordance with the principles of the present invention, usable for detecting microorganisms and particulates in liquid samples, with the sealing elements of the funnel shown in their deflected state;

FIG. 17 is an isometric view, having portions thereof removed, of the assembled components that comprise the third embodiment of the filtration apparatus, constructed in accordance with the principles of the present invention, usable for detecting microorganisms and particulates in liquid samples;

FIG. 17a is a partial cross-sectional view of the bottom portion of the assembly depicted in FIG. 17, showing the filter sealing means, and a means to assist in removing the filter means from the base;

FIG. 18 is an isometric view, having portions thereof removed, of the base component of the assembly depicted in FIG. 17;

FIG. 18a is a magnified partial isometric view of the center portion of the base component depicted in FIG. 18;

FIG. 19 is a isometric view of a vented plug for the outlet port of the base component;

FIG. 20 is a partial cross-sectional view of the bottom portion of the assembly depicted in FIG. 12, showing the filter means permanently sealed to the base;

FIG. 21 is a partial cross-sectional view of the bottom portion of the assembly depicted in FIG. 17, showing the filter means permanently sealed to the base;

FIG. 22 is an isometric view of a filter seal ring;

FIG. 22a is a partial cross-sectional view of the seal ring depicted in FIG. 22;

FIG. 23 is a partial cross-sectional view of an assembly incorporating the filter seal ring depicted in FIG. 22;

FIG. 24 is an exploded isometric view of the components that comprise the sixth embodiment of the filtration apparatus, constructed in accordance with the principles of the present invention, usable for detecting microorganisms and particulates in liquid samples;

FIG. 25 is an isometric view of the funnel element of the apparatus shown in FIG. 24;

FIG. 26 is a partial cross-sectional view of a sub-assembly of the base, absorbent pad, and filter elements of the apparatus shown in FIG. 24;

FIG. 27 is an isometric view, having portions thereof removed, of the assembled filtration apparatus shown in FIG. 24;

FIG. 28 is a partial cross-sectional view of the bottom portion of the assembly shown in FIG. 27.

FIG. 29 is a partial cross-sectional view of the bottom portion of the assembly that comprise the seventh embodiment of the filtration apparatus, constructed in accordance with the principles of the present invention, usable for detecting microorganisms and particulates in liquid samples;

FIG. 30 shows a partial bottom cross-section of two funnels detailing different versions of a integral flexible filter seal;

FIG. 31 is an isometric view, having portions thereof removed, of the base component of the assembly depicted in FIG. 29.

### DETAILED DESCRIPTION OF THE PRIOR ART

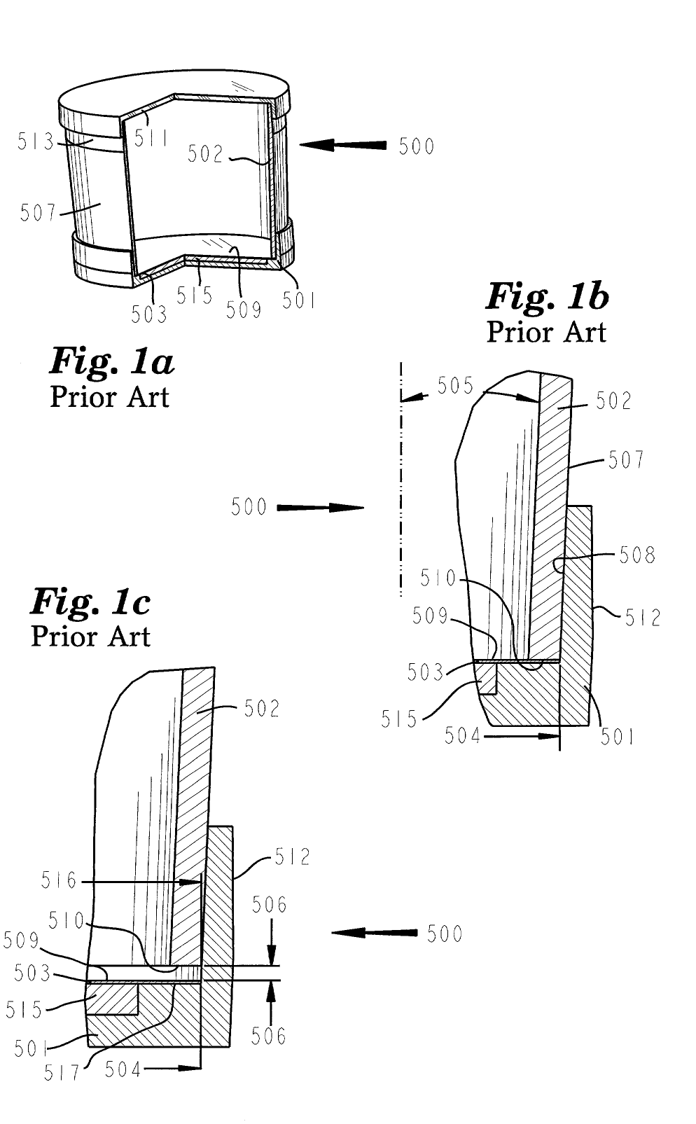

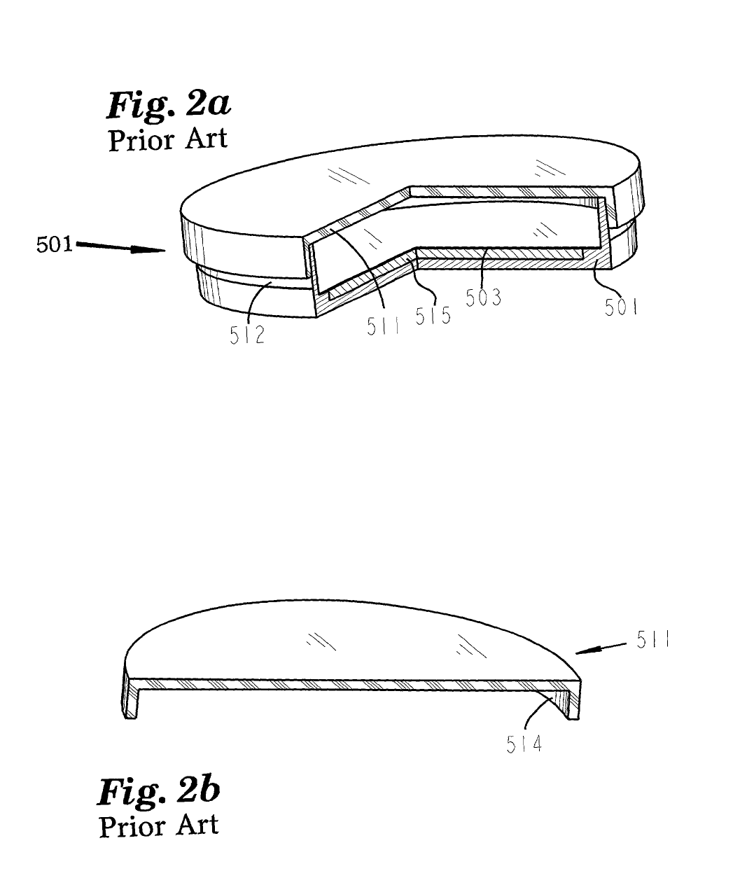

FIG. 1a through FIG. 2b illustrate the first embodiment of the prior art. FIG. 1a is an isometric view, having portions thereof removed, of assembly 500 that contains the component parts of the first embodiment of the prior art. This assembly contains a base 501, a funnel 502, a lid 511, a microporous filter 503, and an absorbent pad 515. The outlet port and absorbent pad support structure of base 501 are not shown for simplicity. Funnel 502 is press fitted into base 501, and lid 511 is press fitted over funnel 502. Absorbent pad 515 is positioned in a well in base 501, with microporous filter 503 resting on top of absorbent pad 515, and with the outer periphery of microporous filter 503 compression sealed between the bottom face 510 of funnel 502 and seal surface 517 of base 501. FIG. 1b is a partial cross-sectional view of assembly 500 showing how funnel 502 is press fitted into base 501. Outer wall 507 of funnel 502 engages inner wall 508 of base 501. Referring to FIG. 1c, diameter 504 is the inside diameter of base 501 at the top face 509 of microporous filter 503, and diameter 516 is the outside diameter of funnel 502 at the bottom face 510 of funnel 502. Referring to FIG. 1b, diameter 516 equals diameter 504, and funnel 502 press fits into base 501 so that funnel 502 is press fitted to base 501 with sufficient force to prevent accidental disengagement, and so that the outer periphery of microporous filter 503 is sealed between the bottom face 510 of funnel 502 and seal surface 517 of base 501. FIG. 1c shows that if either the value of diameter 504 is reduced from that shown in FIG. 1b, or if the value of diameter 516 is increased from that shown in FIG. 1b, or if both conditions exist then funnel 502 will press fit into base 501 as shown in FIG. 1c with a gap existing between the bottom face 510 of funnel 502 and the top surface 509 of microporous filter 503. With the condition shown in FIG. 1c, the microporous filter 503 will not be sealed between the bottom face 510 of funnel 502 and the seal surface 517 of base 501, hence when a vacuum source is applied to the downstream side of absorbent pad 515 through an outlet port (not shown), liquid in the funnel will be drawn through microporous filter 503, and then through absorbent pad 515 into the vacuum source, and a portion of said liquid in funnel 502 may bypass around the outer edge of microporous filter 503, and then through absorbent pad 515 into the vacuum source. If microorganisms are contained in the liquid that bypasses microporous filter 503, these microorganisms will not be detected. If either the value of diameter 504 is increased from that shown in FIG. 1b, or if the value of diameter 516 is decreased from that shown in FIG. 1b, or if both conditions exist then a gap will exist between inner wall 508 of base 501 and outer wall 507 of funnel 502, and funnel 502 will not press fit into base 501, thus preventing funnel 502 from being assembled to base 501. Referring to FIG. 1b, the value of angle 505 (the draft angle of outer wall 507 of funnel 502, and the draft angle of inner wall 508 of base 501) is typically between 0.5° and 2.0°. Table 1 below shows how gap 506 will vary relative to draft angle 505, and relative to the dimension tolerance of the molded component parts (i.e. base 501, funnel 502, and lid 511). Because gap 506 is not dependent upon the actual value of diameter 504, or upon the actual value of diameter 516, these dimensions are represented by the symbolic value A, and a specific variation on the value of A. Typically the height of inner wall 508 of base 501 is less than 0.25″, to keep the height of the petri dish to a minimum. It is reasonable to expect that parts molded in resins such as polypropylene or polyethylene or polystyrene, can be molded to dimension tolerances of ±0.003″, and with difficulty ±0.002″. The thickness of microporous filter 503 may vary from a minimum of 0.001″ thick, to a maximum of about 0.012″ thick, depending upon the type of microporous filter needed for the application.

TABLE 1

| | | | | Dimension |
|---|---|---|---|---|
| Angle 505 | Dia. 504 | Dia. 516 | Gap 506 | Tolerance |
| 0.5° | A | A | 0.000″ | ±0.000″ |
| 0.5° | A − 0.001″ | A + 0.001″ | 0.115″ | ±0.001″ |
| 0.5° | A − 0.002″ | A + 0.002″ | 0.229″ | ±0.002″ |
| 0.5° | A − 0.003″ | A + 0.003″ | 0.344″ | ±0.003″ |
| 1.0° | A | A | 0.000″ | ±0.000″ |
| 1.0° | A − 0.001″ | A + 0.001″ | 0.057″ | ±0.001″ |
| 1.0° | A − 0.002″ | A + 0.002″ | 0.115″ | ±0.002″ |
| 1.0° | A − 0.003″ | A + 0.003″ | 0.172″ | ±0.003″ |
| 2.0° | A | A | 0.000″ | ±0.000″ |
| 2.0° | A − 0.001″ | A + 0.001″ | 0.029 | ±0.001″ |
| 2.0° | A − 0.002″ | A + 0.002″ | 0.057″ | ±0.002″ |
| 2.0° | A − 0.003″ | A + 0.003″ | 0.086″ | ±0.003″ |

Referring to Table 1, it can be seen that dimension tolerances of ±0.001″ are not good enough to guarantee that the microporous filter will be sealed between bottom face 510 of funnel 502, and seal surface 517 of base 501. As explained above it is not practical to mold parts to a dimension tolerance of ±0.001″, or better.

Referring to FIG. 1a, FIG. 2a, and FIG. 2b, Lid 511 is press fitted onto the top of funnel 502 so that inner wall 514 of lid 511 engages outer wall 513 of funnel 502. Lid 511 should fit onto funnel 502 tightly enough so that it will not come loose, but not so tight as to make it difficult for the user to remove lid 511 from funnel 502 with one hand. The draft angle of outer wall 513 of funnel 502, and the draft angle of inner wall 514 of lid 511 is typically between 0.5° and 2.0°. The above analysis of the fit between outer wall 507 of funnel 502, and inner wall 508 of base 501 applies to the fit between outer wall 513 of funnel 502 and inner wall 514 of lid 511.

FIG. 2a shows assembly 501, with funnel 502 discarded, and with lid 511 press fitted onto base 501 to form a petri dish. Referring to FIG. 2a and FIG. 2b, Lid 511 is press fitted onto the top of base 501 so that inner wall 514 of lid 511 engages outer wall 512 of base 501. Lid 511 should fit onto base 501 tightly enough so that it will not come loose when inverted, but not so tight as to make it difficult for the user to remove lid 511 from base 501 with one hand. The draft angle of outer wall 512 of base 501, and the draft angle of inner wall 514 of lid 511 is typically between 0.5° and 2.0°. The above analysis of the fit between outer wall 507 of funnel 502, and inner wall 508 of base 501 applies to the fit between outer wall 512 of base 501 and inner wall 514 of lid 511.

From the above analysis it can be seen that because the component parts that comprise assembly 500, and assembly 501, can not be molded to a high enough dimensional tolerance to be able to fit any funnel 502, to any base 501, or to fit any lid 511 to any funnel 502, or to fit any lid 511 to any base 501, it is necessary to match individual parts to make an assembly. This increases production costs, because of the time required to match parts, and because of the large amount of parts that have to be scrapped because they can not be matched. In addition, when a funnel is matched to a base to get a good press fit between outer wall 507 of funnel 502 and inner wall 508 of base 501, a gap 506 may exist between the bottom face 510 of funnel 502 and the top surface 509 of microporous filter 503, so that microporous filter 503 will not be sealed between bottom face 510 of funnel 502 and seal surface 517 of base 501, thus allowing bypass around microporous filter 503 during the filtration process.

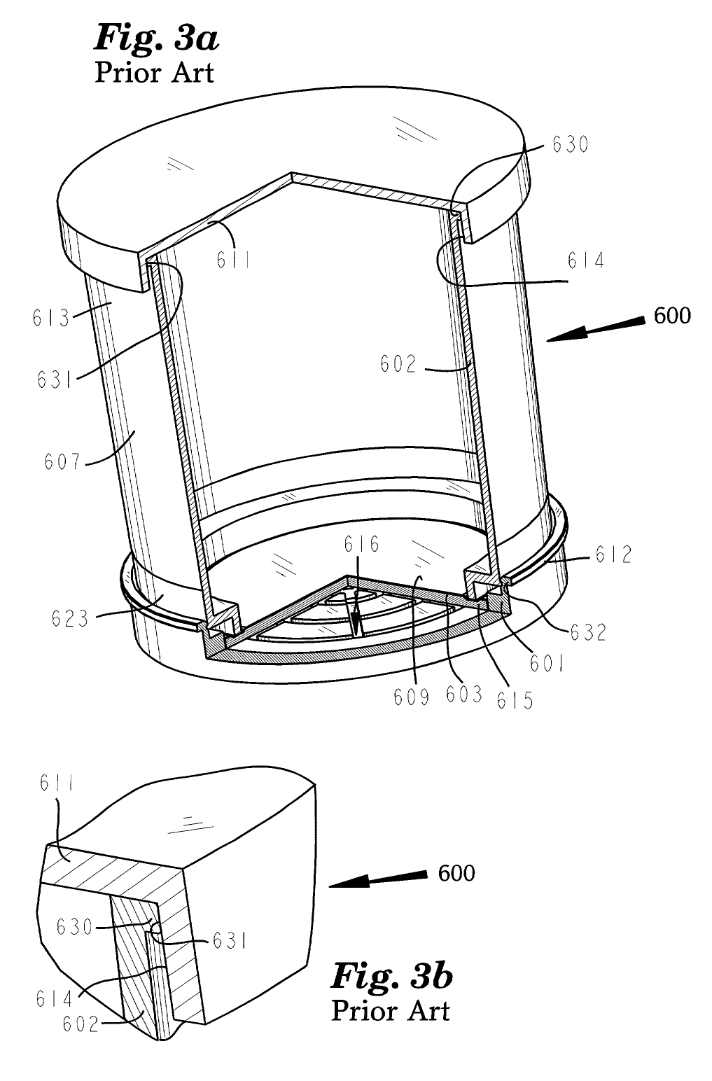

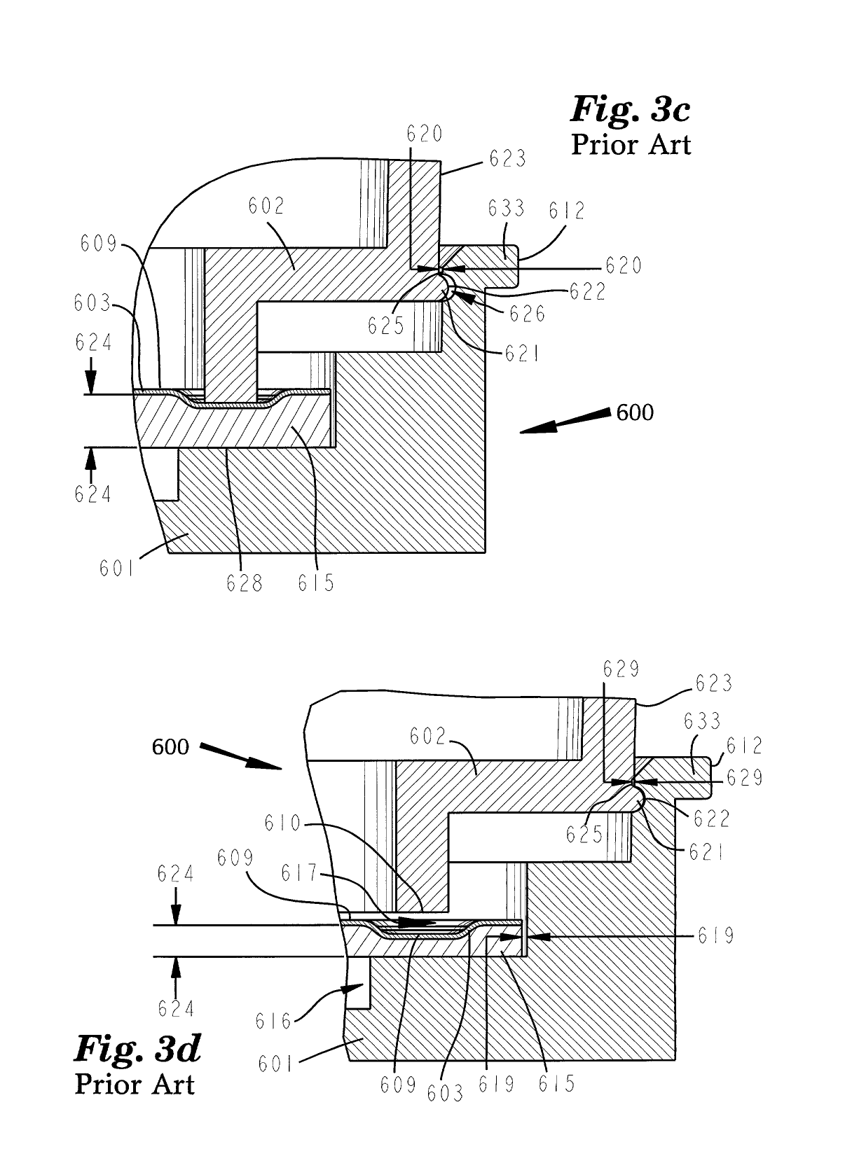

FIG. 3a, FIG. 3b, FIG. 3c and FIG. 3d, depict a second embodiment of the prior art. Assembly 600 contains base 601, funnel 602, lid 611, microporous filter 603, and absorbent pad 615. Lid 611 press fits onto funnel 602 in the same manner described above for lid 511 press fitting onto funnel 502, hence this press fit has the same drawbacks described above. After filtration is complete, funnel 602 is discarded, and lid 611 is press fitted to base 601 to form a petri dish, in the same manner described above for lid 511 press fitting onto base 501, hence this press fit has the same drawbacks described above. Funnel 602 snap fits into base 601, with bead 621 of funnel 602 fitting into groove 626 of base 601. When funnel 602 is properly snap fitted to base 601, microporous filter 603, and absorbent pad 615, are compressed between bottom face 610 of funnel 602, and seal surface 628 of base 601. With this design base 601, and funnel 602 are molded from a pliable material such as polyethylene, or polypropylene.

Referring to FIG. 3c, if outer wall 623 of funnel 602 is smaller in diameter than inner wall 625 of base 601, to create gap 620, then the snap fit will be loose. If gap 620 is large enough, then funnel 602 will not snap fit into base 601, and thus funnel 602 will not be held in place by base 601. Referring to FIG. 3d, if outer wall 623 of funnel 602 is larger in diameter than inner wall 625 of base 601, to create overlap 629, then inner wall 625 of base 601 will stretch, (provided that the overlap is not to great) and the snap fit will fit properly. Although the snap fit shown in FIG. 3a, FIG. 3c, and FIG. 3d, provides for a greater value of dimension tolerance between funnel 602, and base 601, than the press fit described above for assembly 500, in production, with parts molded to a dimensional tolerance of ±0.003″, it may be necessary to match funnels to bases.

Referring to FIG. 3a and 3b, lid 611 is press fitted onto the top of funnel 602 so that inner wall 614 of lid 611 engages outer wall 631 of funnel seal ring 630. Lid 611 should fit onto funnel 602 tightly enough so that it will not come loose, but not so tight as to make it difficult for the user to remove lid 611 from funnel 602 with one hand. Lid 611 is normally molded from a rigid material such as polystyrene, and funnel 602 is normally molded from a more pliable material such as polypropylene. If lid 611, and funnel 602 are both molded with dimension tolerances of ±0.003″, and if under nominal conditions lid 611 press fits onto funnel 602 with 0.001″ of interference between inner wall 614 of lid 611, and outer wall 631 of funnel seal ring 630; then if the diameter of inner wall 614 of lid 611 is molded to its maximum dimension of nominal plus 0.003″, and if the diameter of outer wall 631 of funnel seal ring 630 is molded to its minimum dimension of nominal minus 0.003″, then lid 611 will not press fit onto funnel 602, instead there will be 0.005″ of slop between inner wall 614 of lid 611 and outer wall 631 of funnel seal ring 630, and lid 611 will fall off of funnel 602 if assembly 600 is accidentally tipped on its side. On the other hand if the diameter of inner wall 614 of lid 611 is molded to its minimum dimension of nominal minus 0.003″, and if the diameter of outer wall 631 of funnel seal ring 630 is molded to its maximum dimension of nominal plus 0.003″, then lid 611 will press fit onto funnel 602 with 0.007″ of interference between inner wall 614 of lid 611, and outer wall 631 of funnel seal ring 630. With this much interference it will not be possible to easily position lid 611 onto funnel 602 with one handed operation, nor will it be easy to remove lid 611 from funnel 602 with one handed operation.

When filtration is complete, funnel 602 will be discarded, and lid 611 will be press fitted onto base 601 with inner wall 614 of lid 611 engaging outer wall 612 of base seal ring 632, to form a petri dish like the one shown in FIG. 2a. Lid 611 is normally molded from a rigid material such as polystyrene, and base 601 is normally molded from a more pliable material such as polypropylene. If lid 611, and base 601 are both molded with dimension tolerances of ±0.003″, and if under nominal conditions lid 611 press fits onto base 601 with 0.001″ of interference between inner wall 614 of lid 611, and outer wall 612 of base seal ring 632; then if the diameter of inner wall 614 of lid 611 is molded to its maximum dimension of nominal plus 0.003″, and if the diameter of outer wall 612 of base seal ring 632 is molded to its minimum dimension of nominal minus 0.003″, then lid 611 will not press fit onto base 601, instead there will be 0.005″ of slop between inner wall 614 of lid 611 and outer wall 612 of base seal ring 632, and lid 611 will fall off of base 601 when the petri dish is inverted for incubation. On the other hand if the diameter of inner wall 614 of lid 611 is molded to its minimum dimension of nominal minus 0.003″, and if the diameter of outer wall 612 of base seal ring 632 is molded to its maximum dimension of nominal plus 0.003″, then lid 611 will press fit onto base 602 with 0.007″ of interference between inner wall 614 of lid 611, and outer wall 612 of base seal ring 632. With this much interference it will not be possible to easily position lid 611 onto base 601 with one handed operation, nor will it be easy to remove lid 611 from base 601 with one handed operation.

Referring to FIG. 3a, FIG. 3c, and FIG. 3d, microporous filter 603 and absorbent pad 615 are compressed between bottom face 610 of funnel 602, and seal surface 628 of base 601, as shown in FIG. 3c. During the filtration mode the interior of funnel 602 will contain the liquid to be filtered, with the space above the liquid being at atmospheric pressure. Either lid 611, or funnel 602 contain a venting means (not shown) to maintain the space in funnel 602 above the liquid at atmospheric pressure during the filtration process. This liquid will wet the pores of the microporous filter (i.e. a hydrophilic filter). Filter underdrain 616 is in fluid flow communication with the base outlet port (not shown). When a negative pressure (i.e. vacuum) is applied to the outlet port, and therefore to filter underdrain 616, the pressure on the upstream side of microporous filter 603 will be atmospheric plus the pressure head of the liquid above microporous filter 603, and the pressure below the absorbent pad 615 will be the negative pressure of the vacuum source. Microporous filter 603 will have a pore size of between 0.2 μm, and 1.0 μm, and absorbent pad 615 will have a very large pore size compared to the pore size of microporous filter 603. Therefore, most of the pressure drop (i.e. the difference between the positive pressure on the upstream side of microporous filter 603, and the negative pressure on the downstream side of absorbent pad 615) will occur across microporous filter 603. The pressure drop across microporous filter 603 will be in the approximate range of 10 pounds per square inch, to 14 pounds per square inch. Absorbent pad 615 is made of a material that is easy to compress. Therefore, the force that is applied to the top of microporous filter 603 (by the differential pressure applied across microporous filter 603), will compress absorbent pad 615, as shown in FIG. 3d, and liquid will pass (as shown by arrow 617) through the gap between bottom face 610 of funnel 602, and top face 609 of microporous filter 603, and then into gap 619, through or around absorbent pad 615, and then into the vacuum source, thus bypassing microporous filter 603. If the liquid that bypasses microporous filter 603 contains microorganisms, these microorganisms will not be trapped on the upstream side of microporous filter 603. Therefore these microorganisms will not be detected.

### DETAILED DESCRIPTION OF THE PREFERRED EMBODIMENTS

Although various embodiments of the filtration apparatus constructed in accordance with the present invention are disclosed herein, each embodiment enables the filtration apparatus to be made from component parts that have been molded within a dimensional tolerance range of ±0.004″, and each embodiment provides an integral compression seal of the filter means, for filter means of varying thickness, and each embodiment provides a means to heat seal or otherwise seal the filter means to the base.

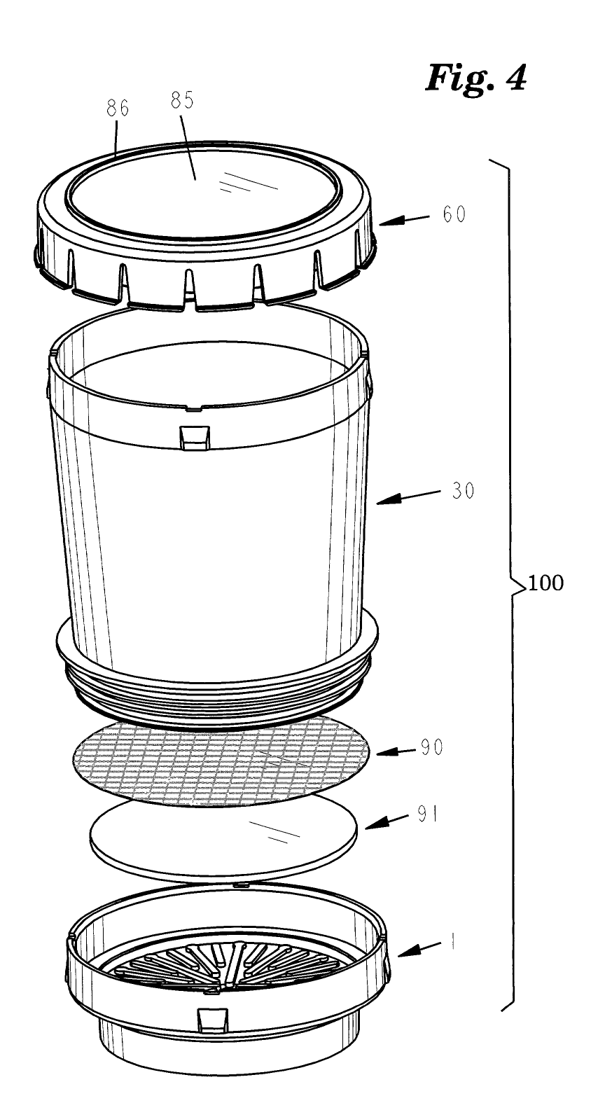

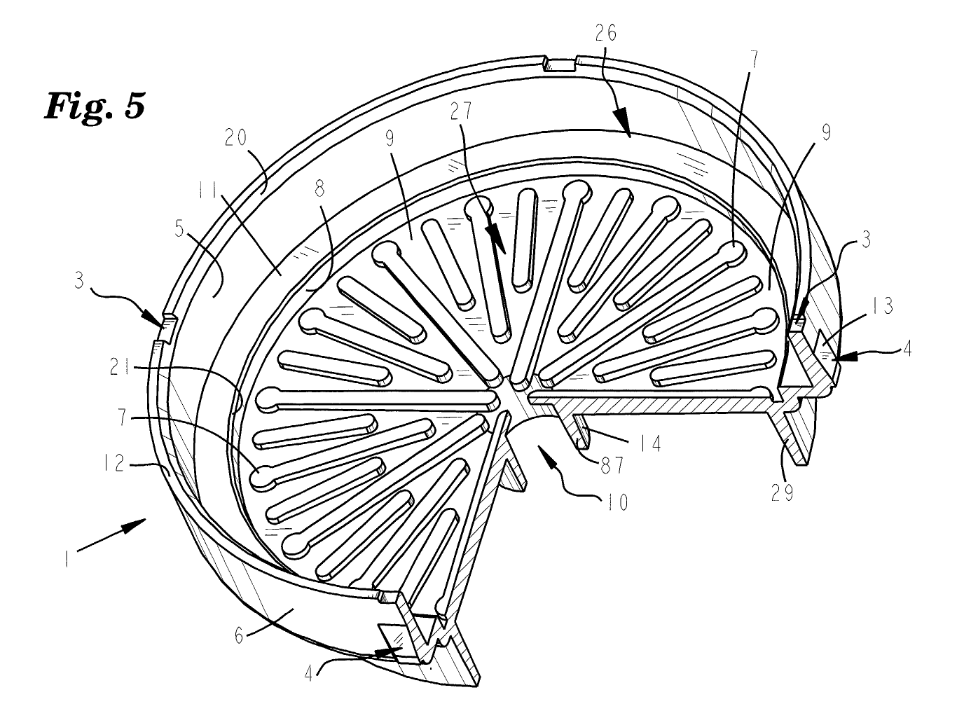

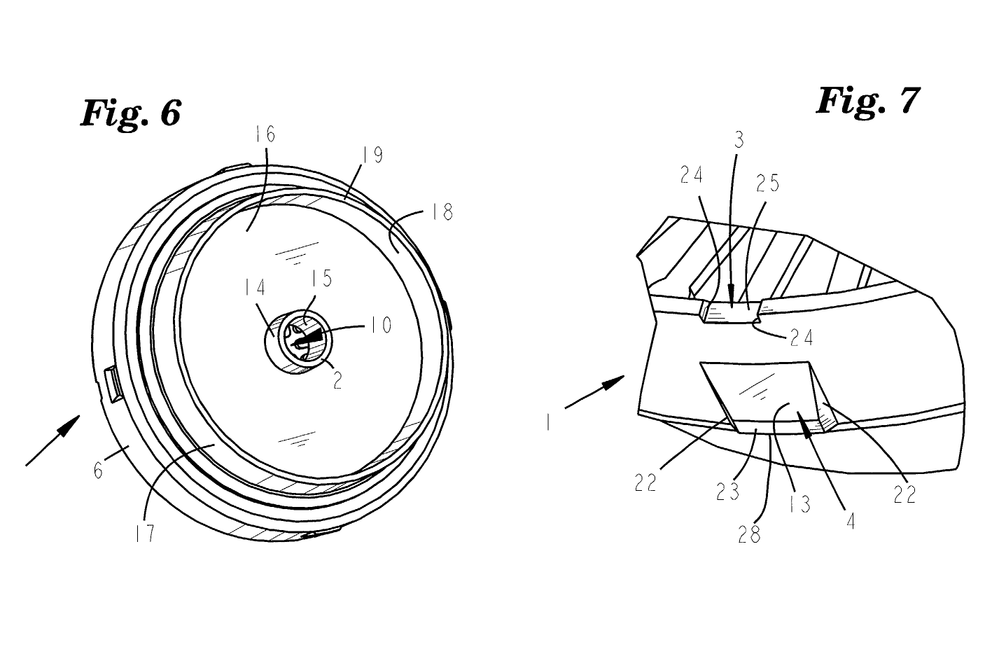

One embodiment of the filtration apparatus constructed in accordance with the principles of the present invention, is shown in FIG. 4 through FIG. 15b. Referring to FIG. 4, exploded assembly 100 contains, base 1, absorbent pad 91, filter means 90 (preferably a microporous filter), funnel 30, and lid 60. Referring to FIG. 5, FIG. 6, and FIG. 7, base 1 contains funnel well 26, bounded by filter seal surface 11, and inside wall 5. Inside wall 5 contains chamfer 20. Base 1 also contains pad well 27 disposed in the bottom of the funnel well, bounded by lower inside wall 8, and bottom inside surface 9. The common edge between filter seal surface 11 and lower inside wall 8, may contain round 21. Base 1 contains outlet port 10. Bottom inside surface 9 may slope downward from its outside periphery toward outlet port 10. Outlet port 10 is in fluid flow communication with pad well 27. Base 1 also contains a means to support absorbent pad 91, shown here by pad support ribs 7, which protrude upward from bottom inside surface 9. The top surface of pad support ribs 7 preferably lie in a horizontal plane, said plane being located below filter seal surface 11, a distance approximately equal to the thickness of absorbent pad 91. Although pad support ribs 7 are shown as radial ribs, any filter support structure that provides sufficient support to absorbent pad 91, and that provides the proper drainage of filtered liquid from pad well 27 to outlet port 10 may be used. Top outer wall 12 of base 1 contains one or more vent slots 3, bounded by side walls 24, and bottom wall 25. Outside wall 6 of base 1 contains one or more lid clamp tabs 4, that protrude from outside wall 6. Each lid clamp tab 4 is bounded by side walls 22, bottom wall 28, sloped surface 13, and outer surface 23. Sloped surface 13 may terminate at bottom wall 28, thus eliminating outer surface 23. The one or more lid clamp tabs 4 should be positioned so that the bottom edge of each lid clamp tab is equidistant from top outer wall 12 of base 1. Base 1 also contains support ring 29, which protrudes from bottom outside wall 16, and is bounded by inner side surface 18, outer side surface 17, and bottom surface 19. Support ring 29 supports base 1 when base 1 is placed on a flat surface. Outlet tube 87 protrudes from bottom outside wall 16, and is bound by outlet tube outside surface 14, outlet tube inside surface 15, and outlet tube bottom surface 2. Outlet port 10 is bound by outlet tube inside surface 15. Outlet port 10 is in fluid flow communication with pad well 27.

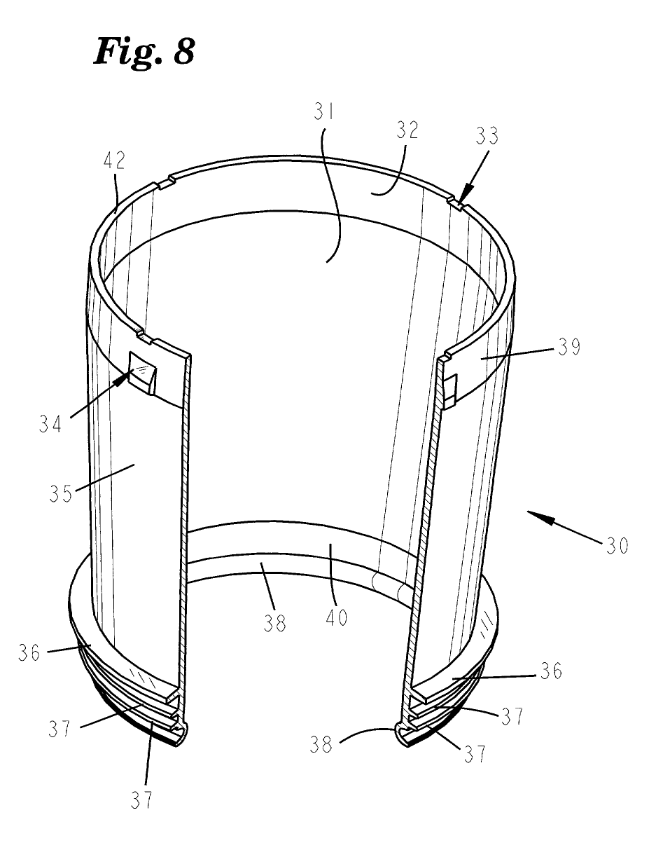

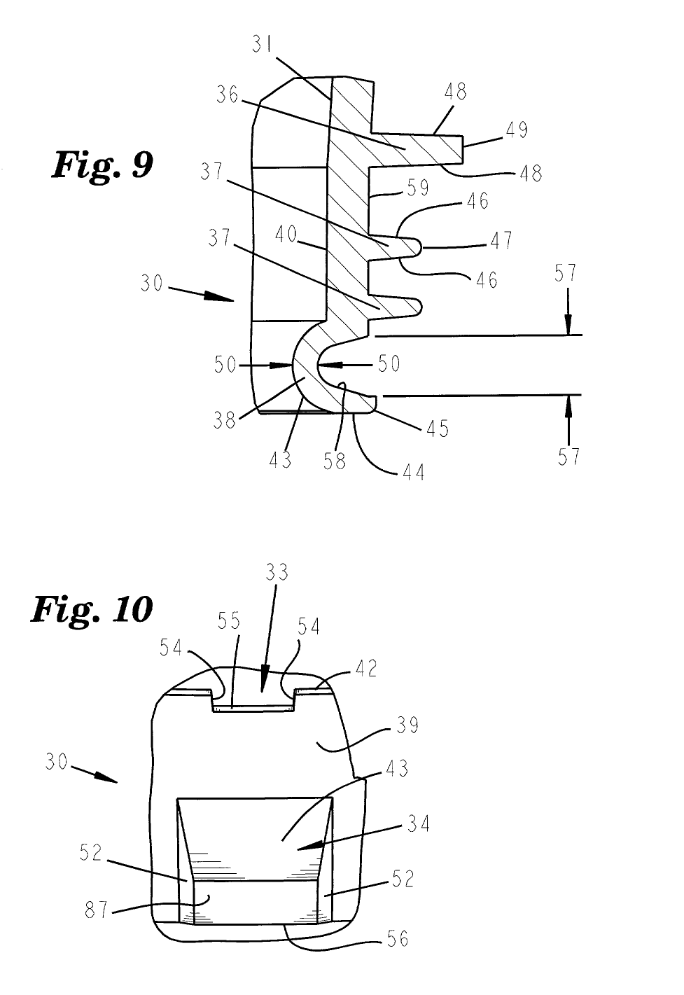

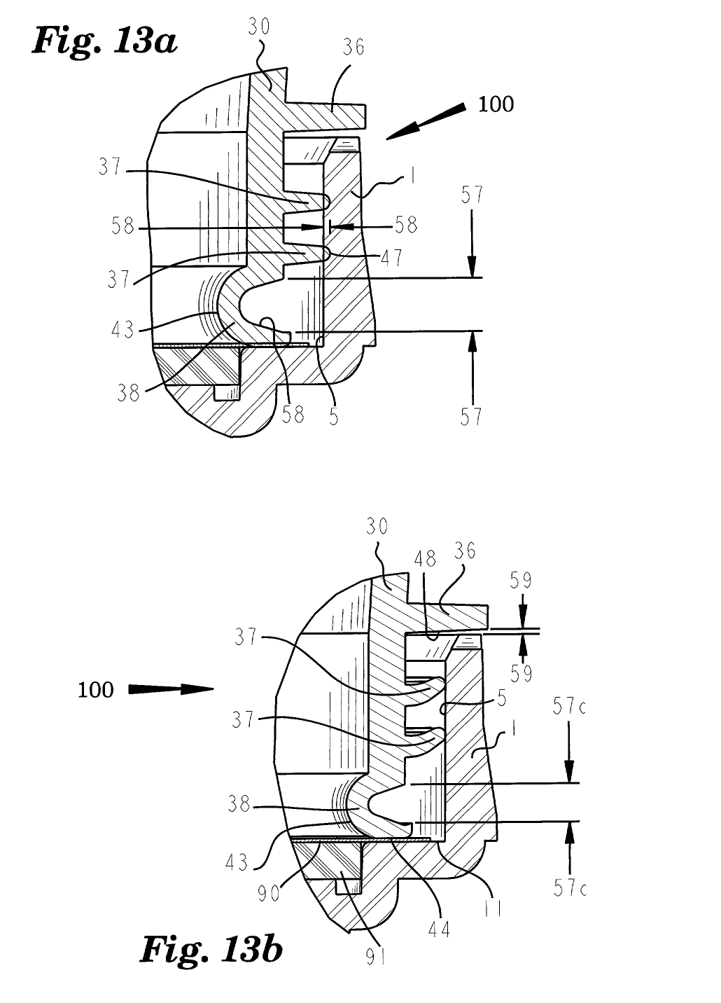

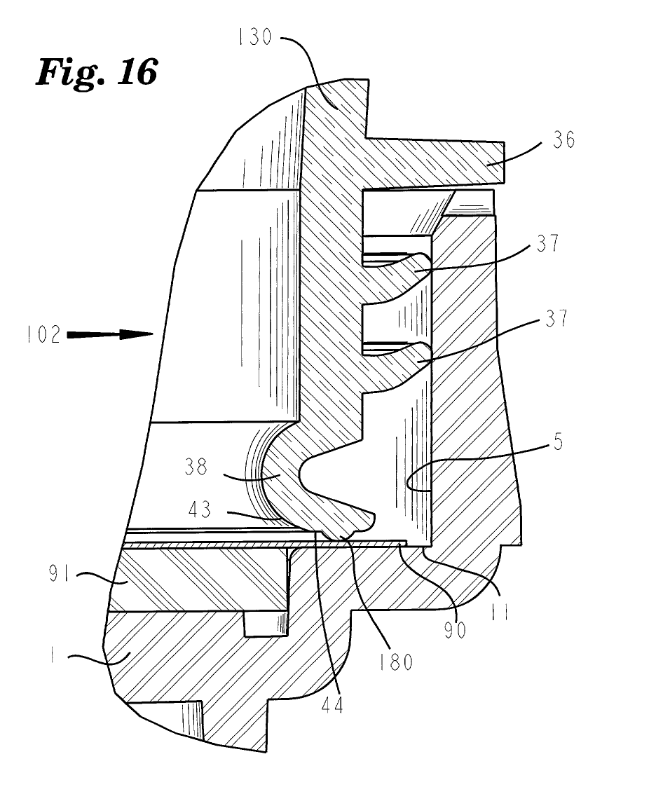

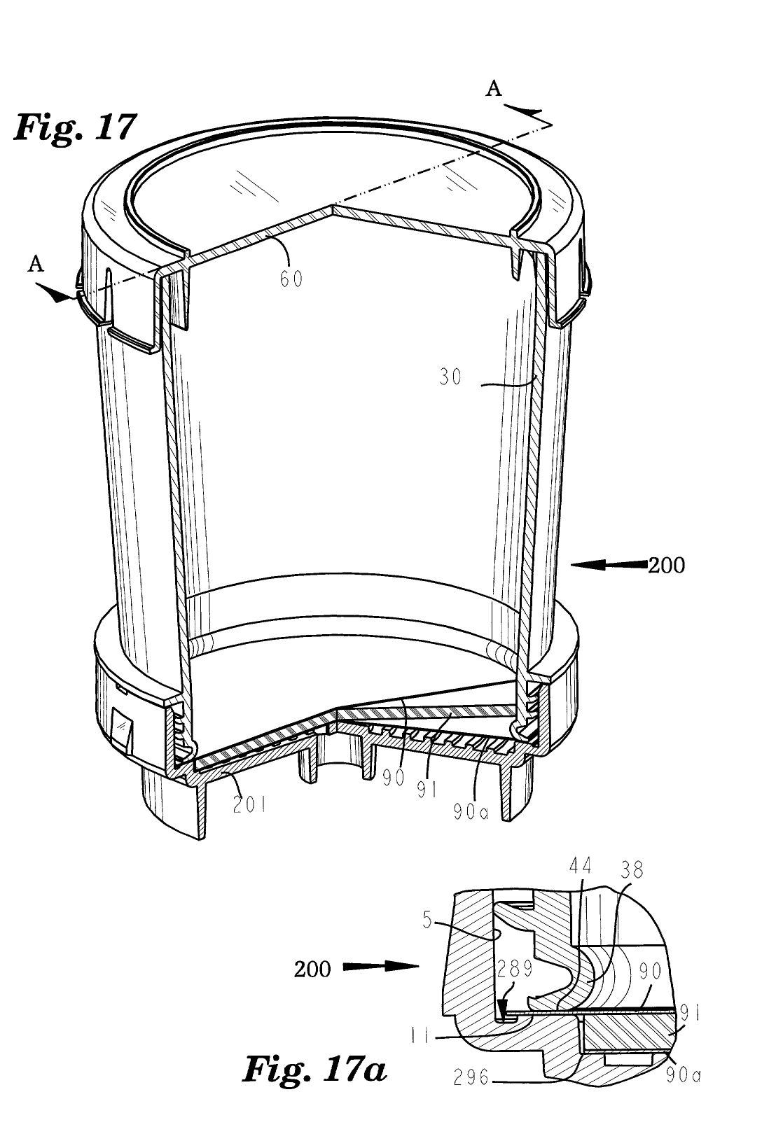

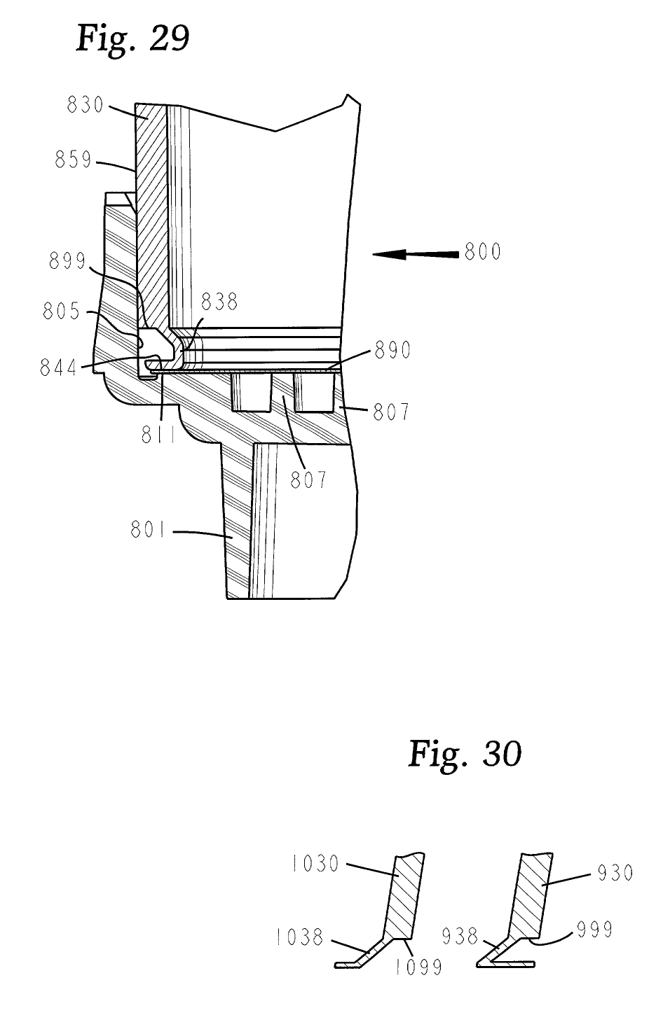

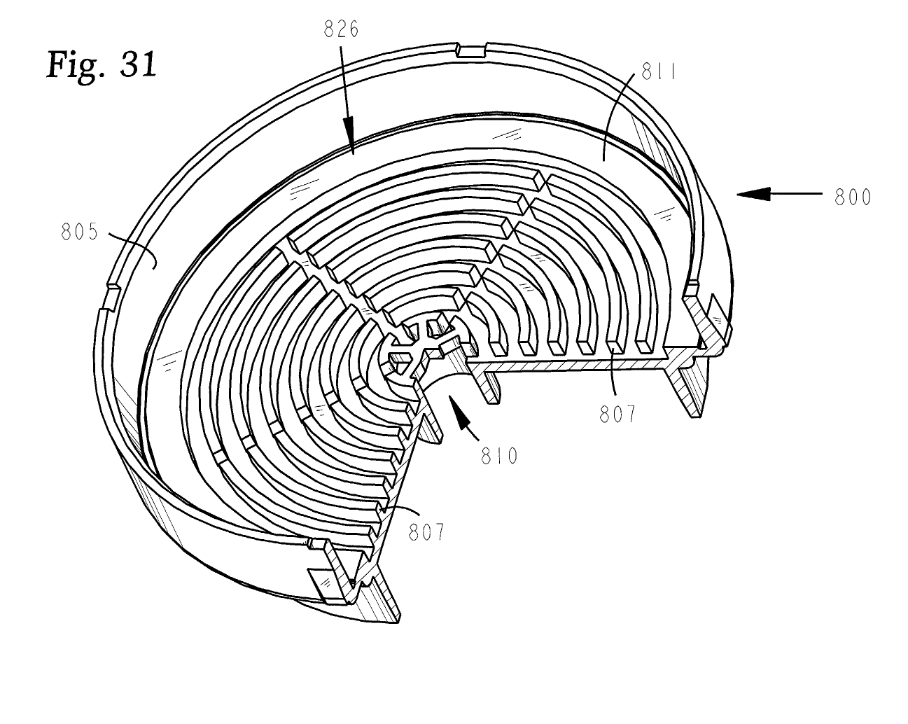

Details of funnel 30 are shown in FIG. 8, FIG. 9, and FIG. 10. The bottom of funnel 30 contains an integral flexible filter seal 38, disposed around the bottom of funnel 30, bound by inner surface 43, outer surface 58, and bottom surface 44. Inner surface 43 is preferably formed by revolving a round section around the central axis of funnel 30, with the top of said round attached to the bottom inside edge of inner wall 40 of funnel 30 as depicted in FIG. 9. Bottom surface 44 is preferably flat and contains round 45 at its outside edge as depicted in FIG. 9. Outer surface 58 is a C-shaped surface as depicted in FIG. 9. Although integral flexible filter seal 38 as shown in FIG. 9 is C-shaped with the open part of the C pointing outward, any shape that allows the seal to compensate for varying filter thickness by flexing could be used, such as a C-shaped integral flexible filter seal with the open part of the C pointing inward, or the types of integral flexible filter seals shown in FIG. 29 as integral flexible filter seal 838, and in FIG. 30 as integral flexible filter seal 938 or as integral flexible filter seal 1038. All of the integral flexible filter seals shown in the FIG. 9, FIG. 13a, FIG. 13b, FIG. 16, FIG. 17a, FIG. 20, FIG. 21, FIG. 23, FIG. 28, FIG. 29, and FIG. 30 protrude from the bottom surface of the funnel. The bottom surface of the funnel is shown in FIG. 29 as bottom surface 899 of funnel 830, and it is shown in FIG. 30 as bottom surface 999 of funnel 930, and as bottom surface 1099 of funnel 1030. The integral flexible filter seal could however, protrude from the inner wall of the funnel, or from the outer wall of the funnel. The important feature of the integral flexible filter seal is that can flex to maintain a leak tight seal between a portion of the integral flexible filter seal and the filter seal surface of the base, for varying thickness, of the filter means, and/or for dimension variations of either the funnel or the base, or both. Although integral flexible filter seal 38 shown in FIG. 9 is composed of the same material as the rest of the funnel, the funnel could be molded of a first material such as polystyrene in a first molding cycle, and then the integral flexible filter seal 38 could be molded from a second much softer material such as polyethylene or rubber in a second molding cycle. The section of funnel 30 directly above integral flexible filter seal 38 is bound by inner wall 40, and outer wall 59. Inner wall 40 is preferably conical in shape with a draft angle of approximately ½°, to assist in removal from the mold from which it is molded. Outer wall 59 may have the same draft angle as inner wall 40, or it may be vertical. Protruding from outer wall 59 is one or more integral flexible funnel seal ring 37. Each integral flexible funnel seal ring is bounded by side walls 46, and end wall 47. Side walls 46 are preferably tapered to improve moldability, and end wall 47 is preferably round in shape as depicted in FIG. 9. Although one or more integral flexible funnel seal rings 37 are shown in FIG. 9 as being composed of the same material as the rest of the funnel, the funnel could be molded of a first material such as polystyrene in a first molding cycle, and then the one or more integral flexible funnel seal rings 37 could be molded from a second much softer material such as polyethylene or rubber in a second molding cycle. The next section of funnel 30 is conical in shape and is bound by inner wall 31, and outer wall 35. The draft angle of outer wall 35, preferably matches that of inner wall 31 to maintain a uniform wall thickness. Funnel stop 36 protrudes from outer wall 35 and is bound by side walls 48, and end wall 49. Side walls 48 are preferably tapered to improve moldability. The top section of funnel 30 is bounded by inner wall 32, outer wall 39, and top wall 42. Inner wall 32 is conical in shape and preferably has a draft angle of ½° or less. The draft angle of outer wall 39 is preferably the same as the draft angle of outside wall 6 of base 1. Referring to FIG. 8 and FIG. 10, top wall 42 contains one or more vent slots 33, bounded by side walls 54, and bottom wall 55. Outer wall 39 of funnel 30 contains one or more lid clamp tabs 34, that protrude from outer wall 39. Each lid clamp tab 34 is bounded by side walls 52, bottom wall 56, sloped surface 43, and outer surface 87. Sloped surface 43 may terminate at bottom wall 56, thus eliminating outer surface 87. The outside diameter of outer surface 87 of the one or more lid clamp tabs of funnel 30 should equal the outside diameter of outer surface 23 of the one or more lid clamp tabs of base 1. The one or more lid clamp tabs 34 should be positioned so that the bottom edge of each lid clamp tab is equidistant from top wall 42 of funnel 30.

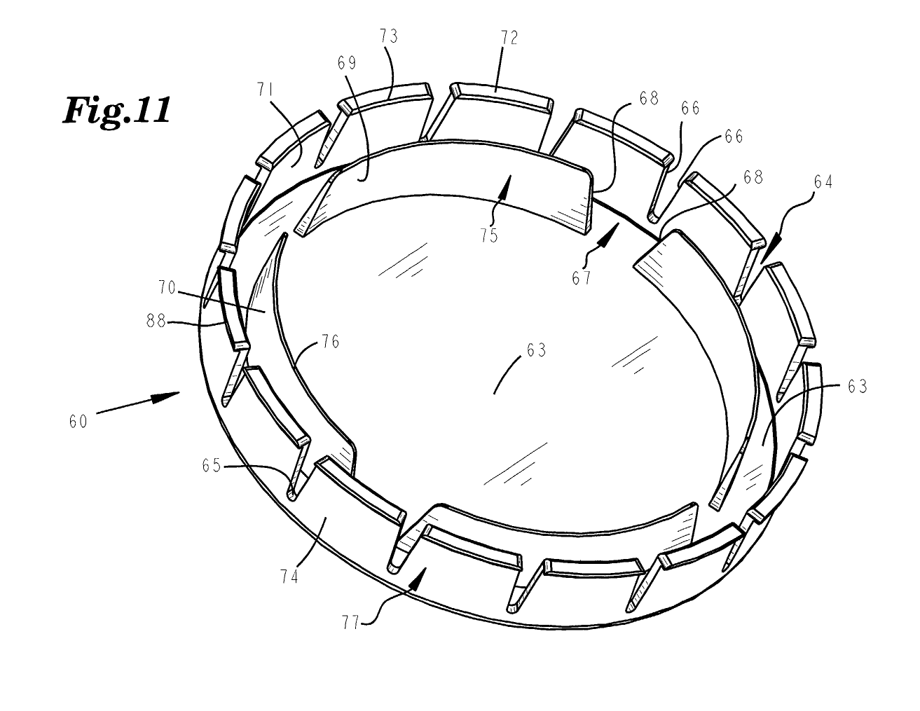

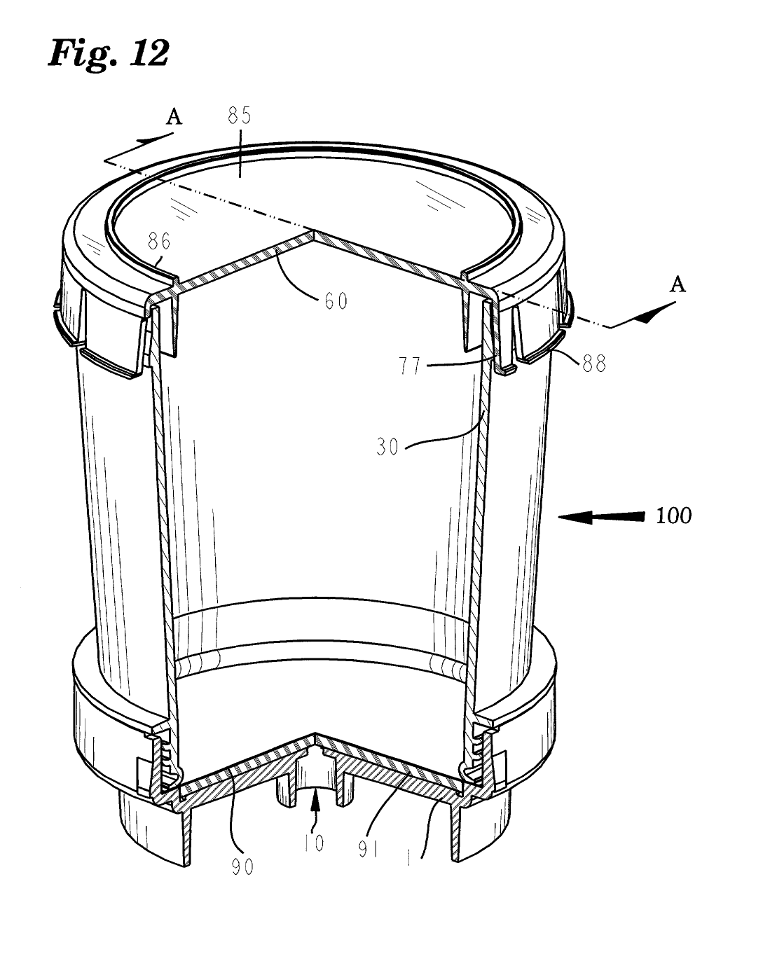

Lid 60 is depicted in FIG. 11 and FIG. 12. Lid 60 contains outer wall 77, bounded by outer surface 74, inner surface 71, and bottom surface 72. The draft angle of inner surface 71, and outer surface 74, are preferably the same as the draft angle of outer wall 39 of funnel 30, and the draft angle of outside wall 6 of base 1. Bottom surface 72 may be extended beyond outer surface 74 to form lip 88. Outer wall 77 contains a plurality of slots 64, each slot 64 is bounded by side surfaces 66, and top surface 65. Each slot creates a gap in bottom surface 72 of lid 60. The top surface 65 of slots 64 is preferably offset from inside top surface 63. Filter hold down ring 75 protrudes from inside top surface 63 and is bounded by inner surface 69, outer surface 70, and bottom surface 76. Filter hold down ring 75 contains one or more slots 67. Nest ring 86 protrudes from outer flat surface 85. The inside diameter of nest ring 86 should be slightly larger than the outside diameter of outer side surface 17, of support ring 29 of base 1, so that the bottom of support ring 29 of base 1 can be nested inside nest ring 86 of lid 60, to enable devices to be stacked on top of each other.

FIG. 12 is an isometric view with portions thereof removed of assembly 100 in its assembled state, shown as the end user would receive it. Referring to FIG. 5, FIG. 6, FIG. 12, FIG. 13a, and FIG. 13b, absorbent pad 91 is positioned in pad well 27, of base 1, and filter means 90 is positioned in funnel well 26 of base 1, with the downstream surface of filter means 90 lying in the same plane as filter seal surface 11 of base 1. FIG. 13a is a partial cross-sectional view of assembly 100, showing theoretically how funnel 30 would fit into base 1, without deflection of the funnel elements. Referring to FIG. 13a, and FIG. 13b, the outside diameter of one or more integral flexible funnel seal ring 37 of funnel 30 must be greater than the inside diameter of inside wall 5 of funnel well 26 of base 1, for the end wall 47 of integral flexible funnel seal ring 37 to seal to inside wall 5 of funnel well 26 of base 1. FIG. 13a shows that if the outside diameter of integral flexible funnel seal ring 37 of funnel 30 is greater than the inside diameter of inside wall 5 funnel well 26 of base 1, the radial overlap dimension 58 can be calculated as follows:

$$\frac{\begin{matrix}( ( outside\_dia \_funnel \_seal \_ring \_ 37 ) - \\ ( inside\_dia \_inside \_wall \_ 5 ) )\end{matrix}}{2} = dimension\_ 58$$

If all parts are assumed to be molded within a dimensional tolerance range of ±0.004″, and if radial overlap dimension 58 equals 0.002″ when the outside diameter of integral flexible funnel seal ring 37 of funnel 30 is at its minimum value, and the inside diameter of inside wall 5 of funnel well 26 of base 1 is at its maximum value, then overlap 58 will equal 0.010″ when the outside diameter of integral flexible funnel seal ring 37 is at its maximum value, and the inside diameter of inside wall 5 of funnel well 26 of base 1 is at its minimum value. The one or more integral flexible funnel seal rings allows the funnel to be releasably attached to the base over a much greater range of dimensional tolerances of both the base and the funnel, than an o-ring seal would allow. Dimension 57 is the uncompressed dimension of the open end of C-shaped outer surface 58 of integral flexible filter seal 38 of funnel 30.

FIG. 13b is a partial cross-sectional view of assembly 100, showing how funnel 30 actually fits into base 1. Referring to FIG. 5, FIG. 6, FIG. 9, and FIG. 13b, when the lower portion of funnel 30 is inserted into funnel well 26 of base 1, the one or more integral flexible funnel seal rings 37 are forced to deflect upward as shown in FIG. 13b, thereby releasably attaching funnel 30 to base 1 with an interference fit between end wall 47 of one or more integral flexible funnel seal rings 37 of funnel 30 and inside wall 5 of funnel well 26 of base 1. Chamfer 20 of base 1 guides one or more integral flexible funnel seal rings 37 into funnel well 26 of base 1 during the assembly of the funnel to the base. Funnel 30 is pressed into base 1 until side wall 48 of funnel stop 36 of funnel 30, hits top outer wall 12 of base 1, so that dimension 59 shown in FIG. 13b becomes zero, thus funnel stop 36 limits the distance funnel 30 can be inserted into base 1. Funnel stop 36 also acts as a dust cap. Once funnel 30 is inserted into base 1, with one or more integral flexible funnel seal rings 37 deflected upward as shown in FIG. 13b, the upward deflection of one or more integral flexible funnel seal rings 37 will prevent funnel 30 from accidentally disengaging from base 1. The thickness and diameter of the one or more integral flexible funnel seal rings 37 should be sized so that funnel 30 is releasably attached to base 1 with sufficient force to prevent accidental disengagement of funnel 30 from base 1, but not with enough force to make it difficult for the end user to remove funnel 30 from base 1 when the filtration process is complete. Integral flexible filter seal 38 of funnel 30 is compressed from its uncompressed dimension 57 shown in FIG. 13a, to its compressed dimension 57c, shown in FIG. 13b, thus releasably sealing filter means 90 between filter seal surface 11 of base 1, and bottom surface 44 of integral flexible filter seal 38 of funnel 30. By making dimension 57 sufficiently large, integral flexible filter seal 38 can provide a leak tight seal for any type of filter means with a thickness ranging from a minimum of zero to a maximum of 0.025″ or more. Microporous filters are commonly used in applications for detecting bacteria, yeast, or mold, and range in thickness from 0.001″ to 0.012″. Funnel stop 36 assures that integral flexible filter seal 38 will not be over compressed. It is desired that the downward force exerted on the top face of filter means 90 by bottom surface 44 of integral flexible filter seal 38 be sufficient to seal filter means 90, and thus prevent bypass of the filtered liquid around filter means 90, but not be so great as to prevent filter means 90 from expanding radially as filter means 90 swells when it becomes wet from the liquid being filtered. Referring to FIG. 9, dimension 50, and dimension 57, combined with the location of funnel stop 36 relative to bottom surface 44 of integral flexible filter seal 38, will determine the downward force exerted on the top surface of filter means 90, by bottom surface 44 of integral flexible filter seal 38, when funnel 30 is inserted into base 1.

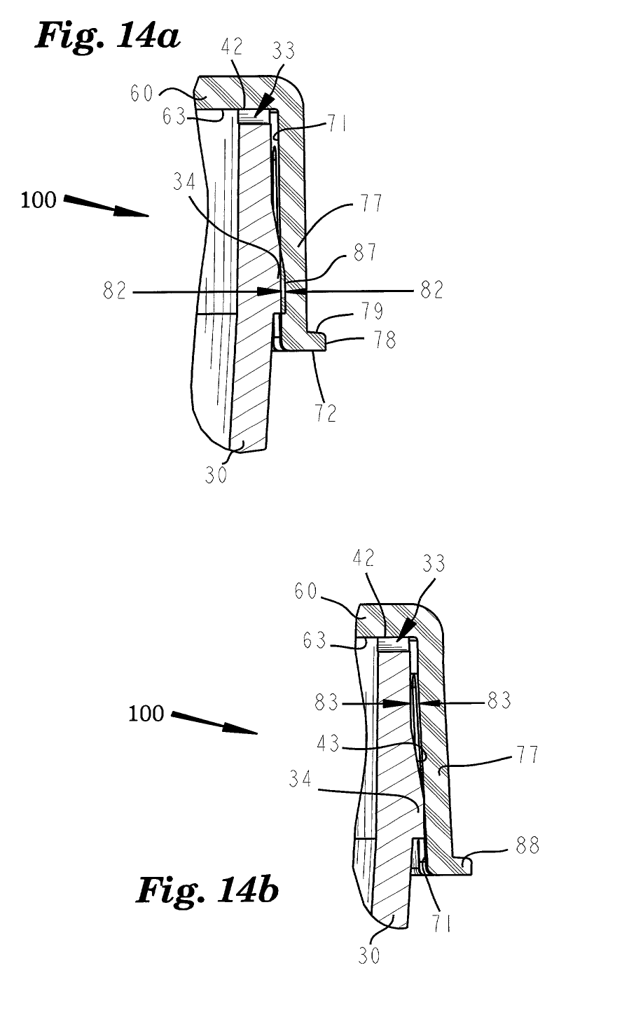

Referring to FIG. 8, FIG. 10, FIG. 11, FIG. 12, FIG. 14a and FIG. 14b, lid 60 is positioned on the top of funnel 30. FIG. 14a shows theoretically how lid 60 fits onto funnel 30, with outer wall 77 of lid 60 in its relaxed position. Referring to FIG. 10, FIG. 14a, and FIG. 14b, the outside diameter of outer surface 87 of each lid clamp tab 34 of funnel 30 must be greater than the inside diameter of inner surface 71 of lid 60, for lid 60 to fit on funnel 30 with an interference fit, to assure that lid 60 will not accidentally fall off of funnel 30. FIG. 14a shows that if the outside diameter of outer surface 87 of one or more lid clamp tabs 34 of funnel 30 is greater than the inside diameter of inner surface 71 of lid 60, the radial overlap dimension 82 can be calculated as follows:

$$\frac{\begin{matrix}( ( outside\_dia \_lid \_clamp \_tab \_ 34 ) - \\ ( inside\_dia \_inner \_surface \_ 71 ) )\end{matrix}}{2} = dimension\_ 82$$

If all parts are assumed to be molded within a dimensional tolerance range of ±0.004″, and if radial overlap dimension 82 equals 0.002″ when the outside diameter of outer surface 87 of one or more lid clamp tabs 34 is at its minimum value, and the inside diameter of inner surface 71 of lid 60 is at its maximum value, then overlap 82 will equal 0.010″ when the outside diameter of outer surface 87 of one or more lid clamp tabs 34 is at its maximum value, and the inside diameter of inner surface 71 of lid 60 is at its minimum value.

FIG. 14b shows how lid 60 actually fits onto funnel 30. When lid 60 is properly positioned on funnel 30, inside top surface 63 of lid 60 will be in contact with top wall 42 of funnel 30, and each segment of outer wall 77 of lid 60 that is in contact with a lid clamp tab 34 of funnel 30, will be bent out so that inner surface 71 of lid 60 is in contact with a outer surface 87 of a corresponding lid clamp tab 34. The height of inner surface 71 of outer wall 77 of lid 60 should be equal to or greater than the distance between top wall 42 of funnel 30 and the bottom edge of each lid clamp tab 34 of funnel 30, and equal to or greater than the distance between top outer wall 12 of base 1 and the bottom edge of each lid clamp tab 4 of base 1 (shown in FIG. 5). Because outer wall 77 of lid 60 is segmented by slots 64, each lid clamp tab 34 of funnel 30 will force one and possibly two segments (two segments if lid 60 is aligned so that a slot 64 of lid 60 rests against outer surface 87 of a lid clamp tab 34) to bend outward when lid 60 is positioned on the top of funnel 30. The maximum width of slot 64 of lid 60 must be less than the width of outer surface 87 of lid clamp tab 34 of funnel 30. By increasing the number of slots 64 of lid 60, the length of each segment of outer wall 77 of lid 60 between adjacent slots 64 will be reduced. As the length of each segment is reduced, the curvature of each segment will be reduced, therefore, the flexibility of each segment will be increased, thus enabling the segment to bend outward without breaking, even when the lid 60 is molded from a stiff material such as polystyrene. As lid 60 is placed on funnel 30, sloped surface 43 of lid clamp tab 34 initially contacts the bottom of inner surface 71 of lid 60. Then as lid 60 is further pressed onto funnel 30, sloped surface 43 causes inner surface 71 of the appropriate segment of outer wall 77 of lid 60 to bend outward gradually until lid 60 is fully seated on funnel 30, and inner surface 71 of said segment of outer wall 77 of lid 60 is in contact with outer surface 87 of the corresponding lid clamp tab 34. This arrangement of segmented outer wall 77 of lid 60 being press fitted onto one or more lid clamp tabs 34 of funnel 30 allows the funnel and lid to be molded within a dimensional tolerance range of ±0.004″ or greater, while providing an adequate interference fit between the lid and funnel to prevent accidental disengagement of the lid from the funnel, while also allowing the end user to place the lid onto the funnel, or to remove the lid from the funnel with one hand. The firmness of the interference fit can be adjusted by increasing the number of lid clamp tabs 34 to increase the firmness, or by decreasing the number of lid clamp tabs 34 to reduce the firmness, while keeping all other variables constant. The dimensional tolerance range of ±0.004″ is well within the normal production range of dimensional tolerances.

Referring to FIG. 8, FIG. 11, and FIG. 14b, when lid 60 is positioned on funnel 30 as described above, the interior of funnel 30 is in air flow communication with the outside atmosphere through one or more vent slots 33 of funnel 30, and gap 83 between inner wall 71 of lid 60 and outer wall 39 of funnel 30. One or more slots 33 could be replaced by one or more grooves in inside top surface 63 of lid 60.

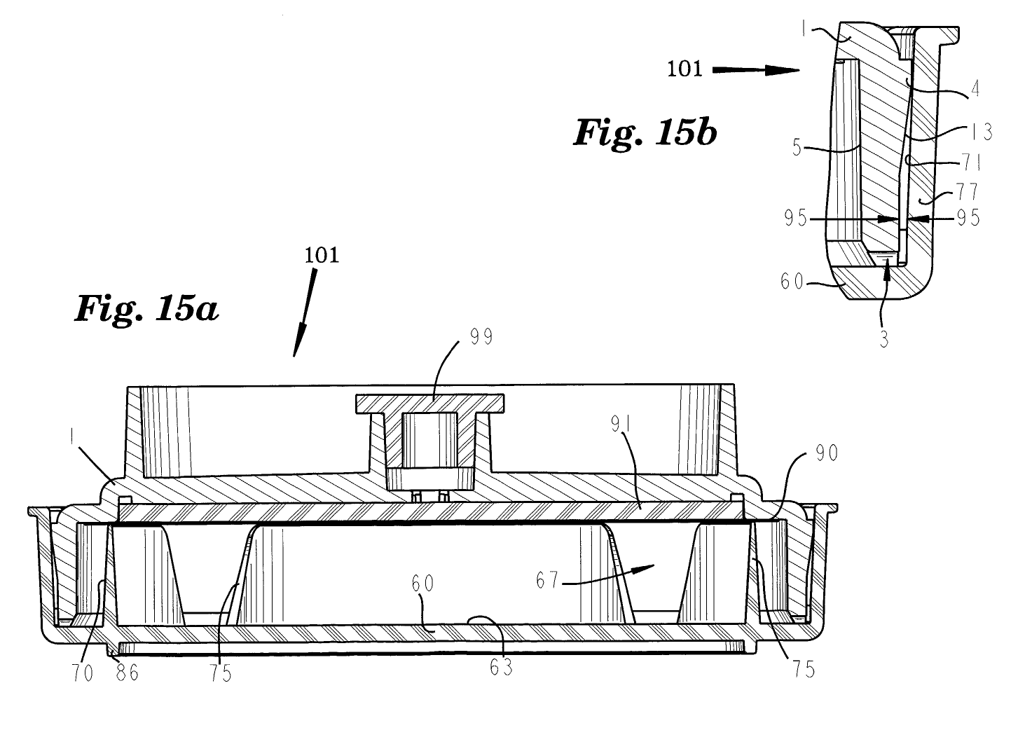

Referring to FIG. 5, FIG. 7, FIG. 10, FIG. 15a and FIG. 15b, when the filtration process is complete funnel 30 is removed from base 1, and lid 60 is removed from funnel 30, lid 60 is then placed onto base 1. Lid 60 will fit on base 1 the same as it fits on funnel 30. The nominal diameter of outer surface 23 of one or more lid clamp tabs 4 of base 1, should be the same as the nominal diameter of outer surface 87 of one or more lid clamp tabs 34 of funnel 30. Assuming that the dimensional tolerance range of base 1 is ±0.004″, the above analysis of how lid 60 fits on funnel 30 applies to how lid 60 fits on base 1, with outer surface 23 of each lid clamp tab 4 of base 1, corresponding to outer surface 87 of each lid clamp tab 34 of funnel 30, and with sloped surface 13 of each lid clamp tab 4 of base 1, corresponding to sloped surface 43 of each lid clamp tab 34 of funnel 30.

Referring to FIG. 5, and FIG. 15b, when lid 60 is positioned on base 1 as described above, the interior of base 1 is in air flow communication with the outside atmosphere through one or more vent slots 3 of base 1, and gap 95 between inner wall 71 of lid 60 and outside wall 6 of base 1. One or more slots 3 could be replaced by one or more grooves in inside top surface 63 of lid 60.

Referring to FIG. 11 and FIG. 15a, when funnel 30 has been removed from base 1, and lid 60 has been placed onto base 1, bottom surface 76 of filter hold down ring 75 of lid 60 holds filter means 90 in place so that the upstream surface of absorbent pad 91 remains in contact with the downstream surface of filter means 90, even when assembly 101 is inverted as shown in FIG. 15a.

Referring to FIG. 5, FIG. 12 and FIG. 15a, the end user will receive the filtration apparatus (i.e. assembly 100) assembled as shown in FIG. 12. Filter means 90 should be a microporous filter with a pore size of 0.45μ or less in applications where it is desired to count cultured bacteria, cultured yeast, or cultured mold. A microporous filter may also be used in applications where it is desired to count particulates, or in applications where it is desired to clarify a solution by filtration. However, in applications where particulates are being counted, or in applications where it is desired to clarify a solution by filtration, filter means 90 may be a screen filter or depth filter. In the following description of the use of assembly 100 it will be assumed that filter means 90 is a microporous filter. The filtration apparatus will preferably be purchased sterile, and will be removed from its packaging and operated in a clean environment (i.e. a laminar flow hood known in the art). The operator will remove lid 60 from funnel 30, and then add a quantity of liquid to be tested to the interior of funnel 30. The liquid will wet filter means 90. A vacuum source is then connected to outlet port 10 of base 1. Outlet port 10 is in fluid flow communication with pad well 27 of base 1, hence the pressure in pad well 27 is the same as the pressure in outlet port 10 (positive or negative). The negative pressure (i.e. vacuum) in pad well 27 of base 1 will suck the liquid in funnel 30 through filter means 90, and then through absorbent pad 91, into pad well 27, into outlet port 10, and then into the vacuum source. This will continue until all of the liquid in funnel 30 has been drawn through filter means 90, and through absorbent pad 91, and until pad well 27 has been emptied. Normally the pore size of filter means 90 is small enough (i.e. approximately 0.45 μm) that the negative pressure of the vacuum does not exceed its bubble point, hence the pores of filter means 90 remain wet. However most if not all of the liquid in absorbent pad may be drawn out because of the large nominal pore size of the absorbent pad. When the filtration step is complete, the vacuum source should be turned off, and the negative pressure in outlet port 10, and hence pad well 27 should be vented to atmospheric pressure.

Referring to FIG. 12, once the filtration step is complete, the user may proceed in one of two ways. The first option is to add a quantity of liquid growth media to funnel 30, and then to momentarily reapply the vacuum to outlet port 10 of base 1. The vacuum will draw the liquid growth media through filter means 90, and then into absorbent pad 91, with any excess liquid growth media going into the vacuum source. It is important that the user turn off the vacuum source and vent outlet port 10 as soon as the level of the liquid growth media in funnel 30 reaches the top surface of filter means 90, to prevent the vacuum source from sucking the liquid growth media out of absorbent pad 91. The pores of filter means 90 will remain wet with liquid growth media because the bubble point of filter means 90 exceeds the pressure differential applied to filter means 90 by the vacuum source (i.e. Vacuum pump). If the vacuum is left on too long the liquid growth media will be sucked out of absorbent pad 91 because of its large nominal pore size, and the subsequent incubation step will give a false result. One way to prevent keeping the vacuum source on to long during the step of adding liquid growth media to the apparatus as just described, is to provide the user with a vacuum pump controller that contains a continuous on/off switch to turn the vacuum pump on or off during the filtration step, and a second pulse switch that turns the vacuum pump on for a predetermined time interval (regardless of how long the user presses the pulse switch) to be used during the step of adding the liquid growth media. The controller should be designed to prevent the user from initiating a second pulse before the first time interval has been completed, this will prevent the user from accidentally turning on the vacuum pump to long, and thus sucking the liquid growth media from absorbent pad 90. The controller may be designed to prevent the start of a second pulse until the first time interval has been completed, and until an additional delay time interval has also been completed. The predetermined time interval of the vacuum pump controller would be set at the factory so that the end user would have to press the pulse switch one or more times to draw the liquid growth media into filter means 90, and into absorbent pad 91, without sucking the liquid growth media out of absorbent pad 91. The user will now remove lid 60 from funnel 30, and then remove funnel 30 from base 1, and then discard funnel 30, and then place lid 60 onto base 1, and then insert outlet port plug 99 into outlet port 10 of base 1, and then place assembly 101 into an incubator, inverted as shown in FIG. 15a. After the proper incubation time assembly 101 will be removed from the incubator, and the top surface of filter means 90 will be examined for growth of bacteria colonies, yeast colonies, or mold colonies. A gridded filter as shown in FIG. 4 may be used to assist in colony counting.

Referring to FIG. 5, FIG. 11, FIG. 12 and FIG. 15a, once the filtration step is complete the second option the user has is to remove lid 60 from funnel 30, and then remove funnel 30 from base 1, and then discard funnel 30, and then place lid 60 onto base 1, and then invert assembly 101, as shown in FIG. 15a. Bottom surface 76 of filter hold down ring 75 of lid 60 holds filter means 90 in place so that the top surface of absorbent pad 91 remains in contact with the bottom surface of filter means 90, when assembly 101 is inverted as shown in FIG. 15a. At this point outlet port 10 of base 1 will be open (i.e. outlet port plug 99 will not be inserted in outlet port 10 as shown in FIG. 15a). A quantity of liquid growth media will now be dispensed into outlet port 10 of base 1. The liquid growth media will flow from outlet port 10 of base 1, into pad well 27 of base 1, and then into absorbent pad 91. Because the pores of filter means 90 remain wetted from the previous filtration step (because the bubble point pressure of filter means 90 is greater than the pressure differential that was applied to filter means 90 by the vacuum), air bubbles may get trapped in absorbent pad 91, as absorbent pad 91 is wetted with the liquid growth media. If an air bubble is trapped at the interface between filter means 90, and absorbent pad 91, the following incubation step may produce a false negative in the region of filter means 90 above said air bubble. The user will now insert outlet port plug 99 into outlet port 10 of base 1, and then place assembly 101 into an incubator, inverted as shown in FIG. 15a. After the proper incubation time assembly 101 will be removed from the incubator, and the top surface of filter means 90 will be examined for growth of bacteria colonies, yeast colonies, or mold colonies. A gridded filter as shown in FIG. 4 may be used to assist in colony counting.

An second embodiment of the filtration apparatus constructed in accordance with the principles of the present invention, is shown in FIG. 16. This embodiment shown as assembly 102 contains the same component parts as the first embodiment described above, with the exception that funnel 30 is replaced with funnel 130. The features of funnel 130 that are identical to those of funnel 30, have been given the same reference numbers as the corresponding feature of funnel 30. In addition to containing all of the features that funnel 30 contains, funnel 130 contains seal bead 180, which protrudes from bottom surface 44, of integral flexible filter seal 38. Although seal bead 180 as illustrated in FIG. 16 is circular in shape, it could be formed from any other shape such as rectangular, elliptical, ect. When funnel 130 is inserted into base 1, integral flexible filter seal 38 of funnel 130 will be compressed as explained above for funnel 30. Hence filter means 90 will be sealed between filter seal surface 11 of base 1, and the bottom of seal bead 180 of funnel 130. The circular shape of seal bead 180 as shown in FIG. 16, and its small contact area with filter means 90, and the spring force applied to seal bead 180 from the compressed integral flexible filter seal 38 of funnel 130 provide a leak tight seal around the outer periphery of filter means 90, and also allows filter means 90 to slide radially outward under seal bead 180, as filter means 90 swells after being wetted with liquid, thus keeping the swelled filter means 90 flat, and in contact with absorbent pad 91. A flat filter means 90, that has its downstream surface in contact with the upstream surface of absorbent pad 91, provides the ideal medium for colony growth in the subsequent incubation phase. Molding funnel 130 from a slippery material such as polypropylene, or polyethylene, lowers the coefficient of friction between the bottom face of seal bead 180 and the top face of filter means 90, thus facilitating the radial expansion of filter means 90 when it is wetted.

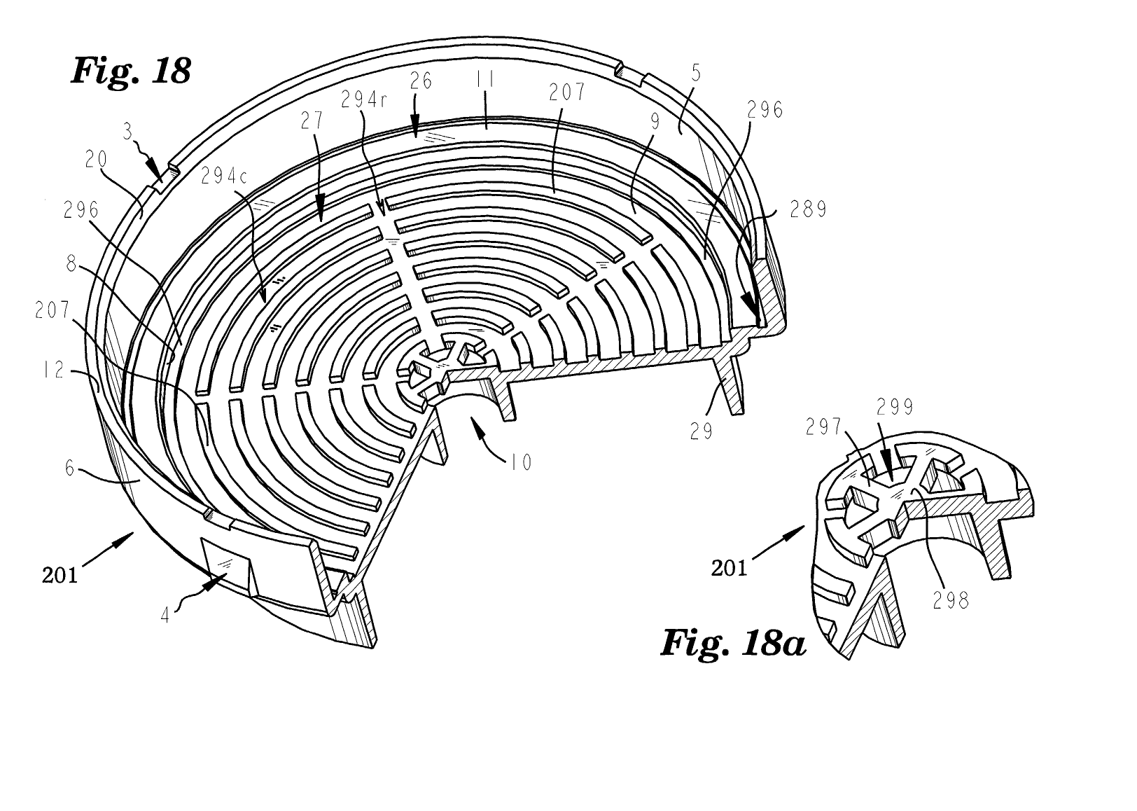

An third embodiment of the filtration apparatus constructed in accordance with the principles of the present invention, is shown in FIG. 17. Assembly 200 shown in FIG. 17 contains, base 201, funnel 30 (alternately funnel 130 could replace funnel 30), lid 60, filter means 90 (preferably a microporous filter), absorbent pad 91, and lower filter means 90a (preferably a microporous filter). Referring to FIG. 18 and FIG. 18a, base 201 contains funnel well 26, bounded by filter seal surface 11, and inside wall 5. Inside wall 5 contains chamfer 20. Base 201 also contains a pad well 27, bounded by lower inside wall 8, and bottom inside surface 9. The outer edge of filter seal surface 11 contains groove 289. Base 201 contains outlet port 10. Bottom inside surface 9 may slope downward from its outside periphery toward outlet port 10. Outlet port 10 is in fluid flow communication with pad well 27. Base 201 also contains a means to support lower filter means 90a, shown here by circular filter support ribs 207, which protrude upward from bottom inside surface 9. Circular filter support ribs 207 are interrupted by one or more radial drain channels 294r. Circular drain channels 294c (i.e. the space between adjacent circular filter support ribs 207), are in fluid flow communication with radial drain channels 294r. Base 201 also contains a means to support the portion of lower filter means 90a that bridges outlet port 10, shown in FIG. 18, and FIG. 18a, as central filter support hub 298, and one or more radial filter support ribs 297 which attach central filter support hub 298 to the inner most circular filter support rib 207. One or more passages 299 place one or more radial drain channels 294r in fluid flow communication with outlet port 10. The top surface of filter support ribs 207 preferably lie in a horizontal plane, said plane being located below filter seal surface 11, a distance approximately equal to the sum of the thickness of absorbent pad 91, plus the thickness of lower filter means 90a. Although circular filter support ribs 207 are shown as segmented circular ribs, any filter support structure that provides sufficient support for lower filter means 90a, and that provides the proper drainage of filtered liquid from pad well 27 to outlet port 10 may be used. Top outer wall 12 of base 201 contains one or more vent slots 3 that correspond to vent slots 3 of base 1. Outside wall 6 of base 1 contains one or more lid clamp tabs 4, that protrude from outside wall 6, that correspond to clamp tabs 4 of base 1. Base 201 also contains support ring 29 corresponding to support ring 29 of base 1. Support ring 29 supports base 201 when base 201 is placed on a flat surface. Outlet port 10 is in fluid flow communication with pad well 27. The outer most circular filter support rib containing seal surface 296 is not interrupted. Referring to FIG. 17 and FIG. 17a, lower filter means 90a is placed into pad well 27 of base 201, so that the downstream surface of lower filter means 90a rests on and is supported by circular filter support ribs 207, central filter support hub 298, and one or more radial filter support ribs 297. The downstream surface of the outer periphery of lower filter means 90a rests on seal surface 296 of the uninterrupted outer most circular support rib. Absorbent pad 91 is placed into pad well 27 of base 201 on top of lower filter means 90a. Filter means 90 is placed into funnel well 26, with the downstream surface of filter means 90 lying in the same plane as filter seal surface 11 of base 201. Referring to FIG. 17a, the outer periphery of filter means 90 is sealed between bottom surface 44 of integral flexible filter seal 38 of funnel 30, and filter seal surface 11 of base 201, and the outer periphery of lower filter means 90a is sealed between seal surface 296 of base 201, and the outer periphery of the bottom face of absorbent pad 91.

The end user will receive the filtration apparatus (i.e. assembly 200) assembled as shown in FIG. 17. The filtration apparatus will preferably be purchased sterile, and will be removed from its packaging and operated in a clean environment (i.e. a laminar flow hood known in the art). The operator will remove lid 60 from funnel 30, and then add a quantity of liquid to be tested to the interior of funnel 30. The liquid will wet filter means 90 and absorbent pad 91. A vacuum source is then connected to outlet port 10 of base 201. Outlet port 10 is in fluid flow communication with one or more radial drain channels 294r of pad well 27 of base 201, through one or more passages 299 of pad well 27 of base 201, and circular drain channels 294c of pad well 27 of base 201 are in fluid flow communication with one or more radial drain channels 294r of pad well 27 of base 201, hence the pressure in pad well 27 is the same as the pressure in outlet port 10 (positive or negative). The negative pressure (i.e. Vacuum) in pad well 27 of base 201 will suck the liquid in funnel 30 through filter means 90, and then n; through absorbent pad 91, and then through lower filter means 90a, into pad well 27, into outlet port 10, and then into the vacuum source. This will continue until all of the liquid in funnel 30 has been drawn through filter means 90, and through absorbent pad 91, and through lower filter means 90a, until pad well 27 has been emptied. Normally the pore size of filter means 90 is small enough (i.e. approximately 0.45 μm) that the negative pressure of the vacuum does not exceed its bubble point, hence the pores of filter means 90 remain wet. The pore size of lower filter means 90a should be just small enough that the negative pressure of the vacuum does not exceed its bubble point (i.e. between 0.8 μm and 1.2 μm), hence the pores of lower filter means 90a will also remain wet, as will absorbent pad 91. When the filtration step is complete, the vacuum source should be turned off, and the negative pressure in outlet port 10, and hence pad well 27 should be vented to atmospheric pressure.

Referring to FIG. 17, once the filtration step is complete, the user will add a quantity of liquid growth media to funnel 30, and then reapply the vacuum to outlet port 10 of base 201. The vacuum will draw the liquid growth media through filter means 90, and then through absorbent pad 91, and then through lower filter means 90a, with any excess liquid growth media going into the vacuum source. Because the bubble points of both filter means 90, and lower filter means 90a are greater than the negative pressure applied by the vacuum source, filter means 90, absorbent pad 91, and lower filter means 90a, will all remain wetted with liquid growth media regardless of how long the vacuum source is kept on. The user will now remove lid 60 from funnel 30, then remove funnel 30 from base 201, then discard funnel 30, then place lid 60 onto base 201, then insert outlet port plug 99 (not shown) into outlet port 10 of base 201, and then place the resultant assembly into an incubator, inverted as described above for the first embodiment. After the proper incubation time the assembly will be removed from the incubator, and the top surface of filter means 90 will be examined for growth of bacteria colonies, or yeast colonies, or mold colonies. Filter means 90 may be a gridded filter to assist the user in colony counting.

In some applications it is desired to skip the step of adding liquid growth media. Instead it is desired to remove filter means 90, from base 201 of the third embodiment (or base 1 of the first or second embodiment), and place filter means 90 into a separate petri dish (not shown) that contains a growth media for the incubation step. Referring to FIG. 17a and FIG. 18, if the outside diameter of filter means 90 is smaller than the outside diameter of groove 289 of base 201, then filter means 90 may be placed into funnel well 26 of base 201 so that the central axis of filter means 90 is aligned with the central axis of funnel well 26 of base 201, or filter means 90 may be placed into funnel well 26 of base 201 so that a portion of the outside edge of filter means 90 contacts a portion of the bottom of inside wall 5 of funnel well 26 of base 201, or filter means 90 may be placed into funnel well 26 of base 201 somewhere in-between these two extremes. The outside diameter of filter means 90 should be made small enough so that regardless of the position of filter means 90 in funnel well 26 of base 201, the user will be able to remove filter means 90 from base 201 (after funnel 30 has been removed from base 201), by placing the tip of a forceps into groove 289 of base 201 at a point where filter means 90 does not cover groove 289, then grabbing the outer periphery of filter means 90 with the forceps and removing filter means 90 from base 201 with the forceps, so that filter means 90 may be placed into a separate petri dish. However, the outside diameter of filter means 90 should be large enough so that regardless of the position of filter means 90 in funnel well 26 of base 201, the outer periphery of filter means 90 will be sealed between bottom surface 44 of integral flexible filter seal 38 of funnel 30 and filter seal surface 11 of base 201.

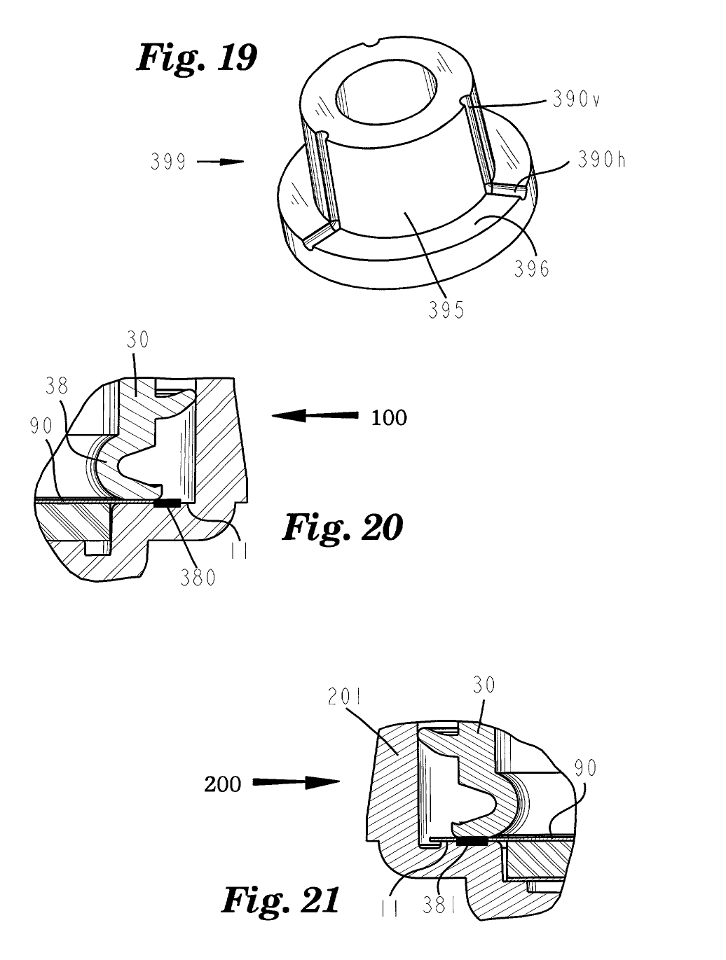

Vented outlet port plug 399, shown in FIG. 19 contains one or more grooves 390v, and an equal number of corresponding grooves 390h. Otherwise vented outlet port plug 399 is identical to outlet port plug 99 shown in FIG. 15a. Referring to FIG. 6, FIG. 15a, and FIG. 19, outlet port plug 99 can be replaced by vented outlet port plug 399. With vented outlet port plug 399 inserted into outlet port 10 of base 1, surface 395 of vented outlet port plug 399 will be press fitted into outlet tube inside surface 15 of base 1, and surface 396 of vented outlet port plug 399 will be releasably sealed to outlet tube bottom surface 2 of base 1, and one or more grooves 390v, and corresponding one or more grooves 390h will place the outside atmosphere in air flow communication with pad well 27 of base 1. There are two advantages to using vented outlet port plug 399. The first advantage is that as vented outlet port plug 399 is inserted into outlet port 10 of base 1 (after the step of adding liquid growth media), it is impossible to create a positive pressure in pad well 27 of base 1, because of the vent grooves on vented outlet port plug 399. When outlet port plug 99 (the non-vented outlet port plug) is press fitted into outlet port 10 of base 1 (after the step of adding liquid growth media), a positive pressure may be developed in pad well 27 of base 1, this positive pressure may dislodge a portion of the downstream surface of filter means 90 from a portion of the upstream surface of absorbent pad 91, possibly preventing colony growth in the dislodged portion of filter means 90 during the incubation process. A second advantage of using vented outlet port plug 399 is that pad well 27 is kept at atmospheric pressure during the incubation step. This will facilitate the flow of liquid growth media from absorbent pad 91, into the pores of filter means 90, to enhance colony growth on the top surface of filter means 90. Vented outlet port plug 399 may also be used with base 201 in the same manner that it is used with base 1.

A fourth embodiment of the filtration apparatus constructed in accordance with the principles of the present invention, is shown in FIG. 20 and FIG. 21. Filter means 90 is permanently sealed to the base of the apparatus in the fourth embodiment. The fourth embodiment can use the same component parts as the first embodiment, or as the second embodiment, or as the third embodiment, or any combination thereof. FIG. 20 using the components of assembly 100, shows that the outer periphery of filter means 90 may be permanently sealed to filter seal surface 11, of base 1, or of base 201, using seal 380 outside of the seal provided by integral flexible filter seal 38 of funnel 30. Seal 380 may be a heat seal, an ultrasonic seal, a solvent seal, a glue seal or any other type of leak tight seal. FIG. 21 using the components of assembly 200, shows that the outer periphery of filter means 90 may be permanently sealed to filter seal surface 11, of base 1, or of base 201, using seal 381 below the seal provided by integral flexible filter seal 38 of funnel 30. Seal 381 may be a heat seal, an ultrasonic seal, a glue seal or any other type of leak tight seal.

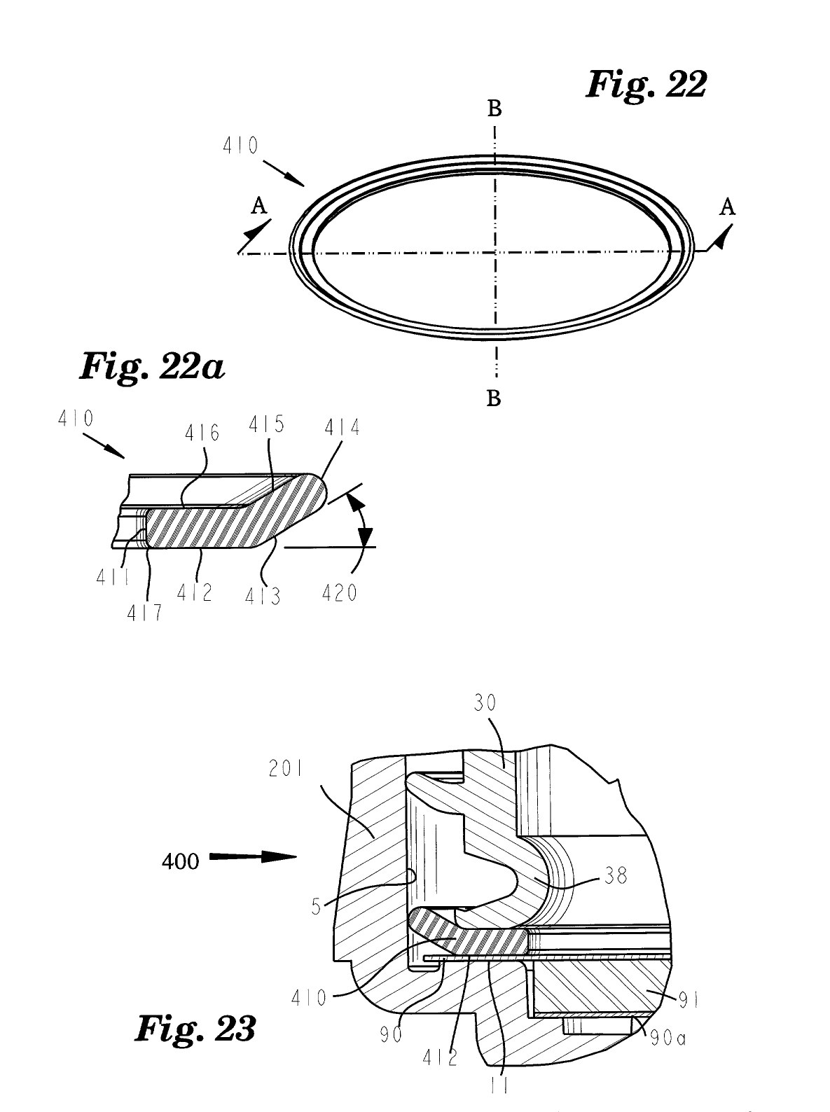

A fifth embodiment of the filtration apparatus constructed in accordance with the principles of the present invention, is shown in FIG. 22, FIG. 22a, and FIG. 23. Filter means 90 is permanently sealed to the apparatus in the fifth embodiment. The fifth embodiment can use the same component parts as the first embodiment, or as the second embodiment, or as the third embodiment, or any combination thereof. FIG. 22 shows filter seal ring 410. FIG. 22a shows a partial cross-section of filter seal ring 410, taken through section A-A, shown in FIG. 22. Referring to FIG. 22a, the bottom of filter seal ring 410 contains filter seal surface 412, and surface 413. Surface 413 is adjacent to filter seal surface 412, and sloped at an angle 420 relative to filter seal surface 412. Surface 416 of filter seal ring 410 is parallel to filter seal surface 412, and surface 415 is parallel to surface 413. End surface 414 is preferably rounded as shown. Surface 411 of filter seal ring 410 preferably contain round 417. Filter seal ring 410 is formed by revolving the section shown in FIG. 22a about axis B-B, shown in FIG. 22. Assembly 400 shown in FIG. 23 uses the same component parts as assembly 200 shown in FIG. 17. Assembly 400 could, however, use the component parts of assembly 100 shown in FIG. 12, or the component parts of assembly 102 shown in FIG. 16. Filter means 90 of assembly 400 is permanently sealed between filter seal surface 412 of filter seal ring 410, and filter seal surface 11 of base 201. End surface 414 of filter seal ring 410 is press fitted to inside wall 5 of funnel well 26 of base 201. Assembly 400 is assembled by the manufacturer by first inserting the necessary filter means and absorbent pad into base 201, and then press fitting filter seal ring 410 into the base. Filter seal ring 410 is preferably molded from a flexible plastic such as polypropylene, or polyethylene. The outside diameter of filter seal ring 410 must be larger than the inside diameter of inside wall 5 of base 201, or of base 1. The prior analysis of dimensional tolerances between integral flexible funnel seal rings 37 of funnel 30, and inside wall 5 of base 1, applies to the fit between filter seal ring 410 and inside wall 5 of base 1, or of base 201. As filter seal ring 410 is pressed into base 1, or base 201, angle 420 of filter seal ring 410 will increase so that end surface 414 of filter seal ring 410 conforms to inside wall 5 of base 1, or of base 201. After the filter seal ring has been pressed into the base, the funnel is then pressed into the base so that the bottom face of integral flexible filter seal 38 of funnel 30 presses against surface 416 of filter seal ring 410. The filter seal ring provides a liquid tight seal while allowing the filter means to expand radially when wetted.

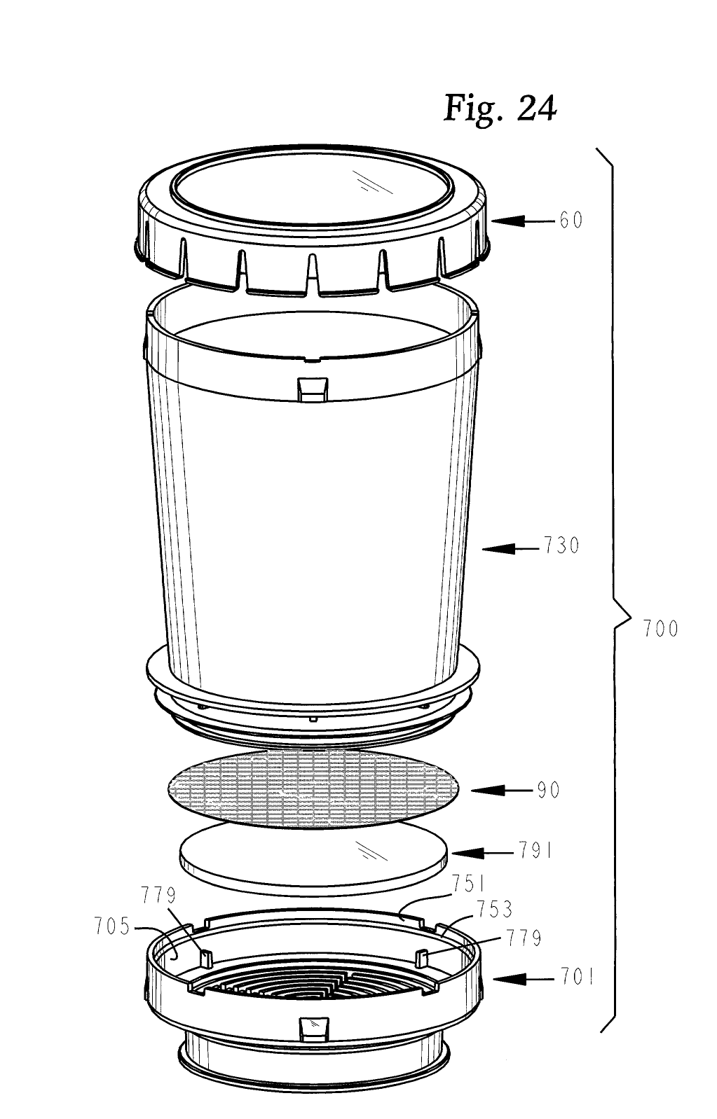

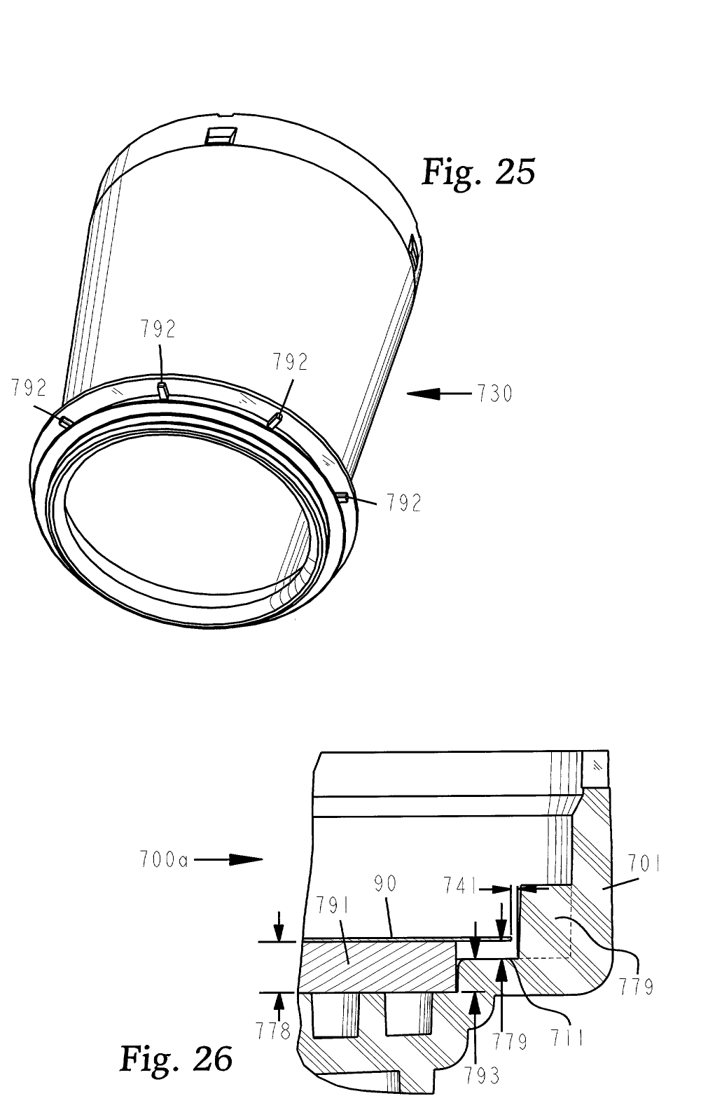

A sixth embodiment of the filtration apparatus constructed in accordance with the principles of the present invention, is shown in FIG. 24 through FIG. 28. FIG. 24 is an exploded view of assembly 700. Assembly 700 contains base 701, absorbent pad 791, filter means 90 (preferably a microporous filter), funnel 730, and lid 60. Base 701 is the same as base 201 shown in FIG. 18 with the exception that base 701 contains three or more filter centering tabs 779 (preferably equally spaced around the periphery of inside wall 705), and a counter bore defined by side wall 751, and chamfer 753. Absorbent pad 791 is the same as absorbent pad 91 shown in FIG. 17, with the exception that absorbent pad 791 is thicker than absorbent pad 91. Absorbent pad 791 may be comprised of two or more thin layers of absorbent pad material. Funnel 730 is the same as funnel 30 shown in FIG. 8, FIG. 12, and FIG. 17, with the exception that funnel 730 contains funnel centering tabs 792. Although funnel 730 is shown with one integral flexible funnel seal ring 737, more than one integral flexible funnel seal ring could be used. Lid 60 is the same as lid 60 shown in FIG. 17.

FIG. 26 shows sub-assembly 700a with absorbent pad 791 positioned in pad well 27 of base 701 (pad well 27 is shown in FIG. 18 and described above), and with filter means 90 positioned on top of absorbent pad 791 and centered in base 701 by three or more filter centering tabs 779. Referring to FIG. 26, the diameter of filter means 90 may be made slightly smaller than the inside diameter of filter centering tabs 779 so that a small gap 741 will exist between one or more filter centering tabs and filter means 741. This small difference in diameter makes it easier to place filter means 90 into base 701. FIG. 26 shows that the thickness 778 of absorbent pad 791 is substantially greater than the height 793 of pad well 27 of base 701. Therefore when the filter means 90 is positioned on top of absorbent pad 791 as shown in FIG. 26, a gap 779 will exist between the downstream side of filter means 90 and filter seal surface 711 of base 701.

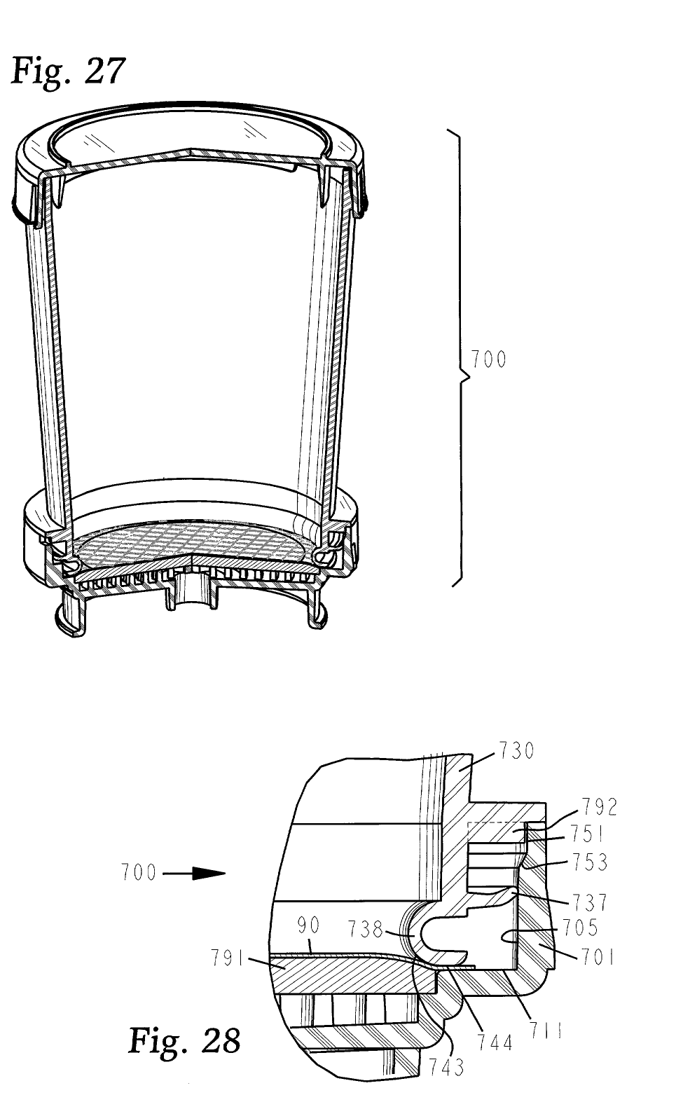

FIG. 27 shows assembly 700 in the assembled state. FIG. 28 is a partial cross-sectional view of a portion of assembly 700 showing in detail how funnel 730 is assembled to base 701. The counter bore at the upper part of inside wall 705 of base 701, defined by side wall 751 and chamfer 753, allows integral flexible funnel seal ring 737 of funnel 730 (in its undeflected state) to be easily located and centered in the top portion of base 701. Chamfer 753 then guides integral flexible funnel seal ring 737 of funnel 730 as it is deflected and pressed into the lower portion of inside wall 705, to attain the press fit shown in FIG. 28. With funnel 730 seated in base 701 as shown in FIG. 28, one or more integral flexible funnel seal rings 737 of funnel 730 will secure funnel 730 to base 701, and three or more funnel centering tabs 792 will be positioned in the counter bore of inside wall 705 of base 701, defined by side wall 751 and chamfer 753. Funnel centering tabs 792 keep funnel 730 centered in base 701. With funnel 730 seated in base 701, bottom surface 744 of integral flexible filter seal 738 of funnel 730, and inner surface 743 of integral flexible filter seal 738 of funnel 730, push down on the outer periphery of filter means 90, so that the outer periphery of filter means 90 is sealed with a compression seal between bottom surface 744 of integral flexible filter seal 738 of funnel 730, and filter seal surface 711 of base 701. Because absorbent pad 791 is substantially thicker than the height of pad well 27 of base 701 (as explained above), the outer periphery of absorbent pad 791 will be compressed by filter means 90 which is in turn compressed by the lower portion of inner surface 743 of filter seal 738, as shown in FIG. 28. Compressed absorbent pad 791 exerts an upward force on filter means 90, thus keeping filter means 90 in tension and wrinkle free.

The end user will use assembly 700 the same as assembly 200 is used, as explained above. When the liquid to be tested is added to funnel 730, filter means 90 and absorbent pad 791 will be wetted. Because filter means 90 is very thin it will not swell appreciably in thickness, but will expand in diameter as it is wetted. If the spring force of integral flexible filter seal 738 of funnel 730 is great enough to prevent filter means 90 from expanding radially between bottom surface 744 of integral flexible filter seal 738 of funnel 730, and filter seal surface 711 of base 701, filter means 90 will wrinkle if an absorbent pad with a thickness approximately equal to the height of pad well 27 is used (as described in the previous embodiments of the present invention). This wrinkling will prevent portions of the downstream surface of filter means 90 from contacting the upstream surface of absorbent pad 791, which in turn will impede colony growth during the incubation cycle. However, when an absorbent pad that has a thickness that is substantially greater than the height of the pad well is used as shown in FIG. 26 and FIG. 28, filter means 90 will start out in tension (i.e. wrinkle free) when dry, and will remain in tension as absorbent pad 791 swells in thickness as it becomes wet. Because the thickness of absorbent pad 791 is much greater than the thickness of filter means 90, absorbent pad 791 will swell much more in thickness than filter means 90 will, thereby keeping filter means 90 in tension and wrinkle free when both the filter means and the absorbent pad are wet. This will assure uniform contact between the downstream surface of filter means 90 and the upstream surface of absorbent pad 791, thus assuring proper incubation of any colonies trapped on the upstream surface of filter means 90, during the incubation cycle. Absorbent pad 791 should be made thick enough to assure that filter means 90 remains wrinkle free throughout the filtration process, but not so thick to cause a brittle filter means to fracture in the region where it is compressed.

Any of the above assemblies can be used to detect particulates in a liquid sample. The procedure is the same with the exception that the addition of liquid growth media, and incubation step are not necessary.d

A seventh embodiment of the filtration apparatus constructed in accordance with the principles of the present invention, is shown in FIG. 29 and FIG. 31. Funnel 830 is press fitted into funnel well 826 of base 801 with an interference fit between outer wall 859 of funnel 830 and inside wall 805 of base 801. In this embodiment the one or more integral flexible funnel seal rings are eliminated. Funnel 830 contains integral flexible filter seal 838, disposed around the bottom edge of funnel 830. Base 801 does not contain a pad well for an absorbent pad disposed in the bottom of funnel well 26. A filter means 890 is compression sealed between bottom surface 844 of integral flexible filter seal 838 of funnel 830, and filter seal surface 811 of base 801. The filter means may be a microporous filter, a screen filter, or a depth filter. The filter means is supported by a filter support means shown as filter support ribs 807 disposed in the bottom of the funnel well. The filter support means could be any filter support arrangement that provides the proper support for the filter means, and that also provides a fluid flow communication means between the downstream side of the filter means, and outlet port 810. The voids around filter support ribs 807 are in fluid flow communication with outlet port 810. Although the apparatus shown in FIG. 29 does not compensate for the range of dimensional tolerances between outer wall 859 of funnel 830, and inside wall 805 of base 801, as a funnel with one or more integral flexible funnel seal rings would, it does provides more compensation than the prior art because of integral flexible filter seal 838. The greater the range of flexing of integral flexible filter seal 838 (i.e. the greater the distance that the integral flexible filter seal can be compressed), the greater the compensation will be.

The apparatus shown in FIG. 29 could be used to count bacterial colonies, yeast colonies, or mold colonies, from a liquid sample as follows: The end user will receive the filtration apparatus (i.e. assembly 800) assembled as shown in FIG. 29. The filtration apparatus will preferably be purchased sterile, and will be removed from its packaging and operated in a clean environment (i.e. a laminar flow hood known in the art). The operator will remove the lid (not shown) from funnel 830, and then add a quantity of liquid to be tested to the interior of funnel 830. The liquid will wet filter means 890. A vacuum source is then connected to outlet port 810 of base 801. The vacuum source will cause the liquid in the funnel to be filtered through filter means 890, with the downstream liquid being sucked into the vacuum source. For this type of application the filter means should be a microporous filter with a pore size of 0.45μ or smaller. The bacteria, yeast, or mold in the liquid sample will be trapped on the upstream surface of filter means 890. Funnel 830 will then be removed from base 805, then filter means 890 will be removed from base 801 as described above, then filter means 890 will be placed into a petri dish that contains the proper growth media (not shown). The petri dish will then be placed into an oven for incubation of the bacteria, or of the yeast, or of the mold. When the incubation cycle is complete the colonies can be counted.

The apparatus shown in FIG. 29 could be used to count particulates in a liquid sample as follows: The end user will receive the filtration apparatus (i.e. assembly 800) assembled as shown in FIG. 29. The filtration apparatus will preferably be purchased sterile, and will be removed from its packaging and operated in a clean environment (i.e. a laminar flow hood known in the art). The operator will remove the lid (not shown) from funnel 830, and then add a quantity of liquid to be tested to the interior of funnel 830. The liquid will wet filter means 890. A vacuum source is then connected to outlet port 810 of base 801. The vacuum source will cause the liquid in the funnel to be filtered through filter means 890, with the downstream liquid being sucked into the vacuum source. For this type of application the filter means could be a microporous filter, a screen filter, or a depth filter, although a microporous filter is preferable with a pore size small enough to trap the smallest particles that are desired to be counted. When the filtration is complete, the particles to be counted will be trapped on the upstream surface of the filter means, where they can be counted either in the funnel, or alternately the funnel can be carefully removed from the base, and then the trapped particles can be counted with the filter in the base, or the filter could be carefully removed from the base for counting.

The vacuum filtration apparatus shown in FIG. 29 could use a funnel without an integral flexible filter seal 838, in which case the filter means 890 would be sealed with a compression seal between filter seal surface 811 of base 801, and bottom surface 899 of funnel 830. In any of the previous embodiments, the integral flexible filter seal could also be eliminated, and the filter means could be sealed between the seal surface of the appropriate base and the bottom surface of the appropriate funnel.

Although the present invention has been shown and described in terms of specific preferred embodiments, it will be appreciated by those skilled in the-art that changes or modifications are possible which do not depart from the inventive concepts described and taught herein. Such changes and modifications are deemed to fall within the purview of these inventive concepts. Any combination of the various features of the preferred embodiments are deemed to fall within the purview of these inventive concepts. In addition it is contemplated that the filter assembly may be employed in an environment other than the detection of microbes, or particulates. A fluid system in which components of the fluid must be removed can benefit from the use of a filter apparatus embodying the teachings of the present invention.

What is claimed:

1. A vacuum filtration apparatus comprising:
a base containing a funnel well with a filter seal surface disposed adjacent to the bottom of the inside wall of said funnel well, with a filter support means disposed in the bottom of said funnel well inside of said filter seal surface, with an outlet port disposed below said filter support means, said outlet port being in fluid flow communication with said filter support means,
a funnel with an open top, with the bottom outside portion of said funnel releasably attached with an interference fit to the inside wall of said funnel well of said base, said funnel containing an integral flexible filter seal disposed around the bottom of said funnel,
a filter means disposed in the bottom portion of said funnel well with the downstream surface of said filter means lying in the same plane as said filter seal surface, said filter means releasably sealed between said filter seal surface of said base and said integral flexible seal of said funnel,
whereby said integral flexible filter seal provides a leak tight releasable seal between said filter seal surface of said base and said integral flexible seal of said funnel for varying thickness, of said filter means.

2. The vacuum filtration apparatus of claim 1 wherein the releasable attachment between said funnel and said base is an interference fit between one or more integral flexible funnel seal rings protruding from the bottom outer periphery of said funnel, and the inside wall of said funnel well of said base,
whereby said one or more integral flexible funnel seal rings provide a releasable attachment between said funnel and said base, over the normal production range of dimensional tolerances of said interior side wall of said funnel well of said base, and over the normal production range of dimensional tolerances of the outer edge of said one or more integral flexible funnel seal rings of said funnel.

3. The vacuum filtration apparatus of claim 1 wherein the top surface of the filter support means is disposed below said filter seal surface, thereby creating a pad well below said filter seal surface.

4. The vacuum filtration apparatus of claim 3 wherein an absorbent pad is disposed in said pad well, with the downstream surface of said absorbent pad resting on the top surface of said filter support means, and with a portion of the downstream surface of said filter means resting on the upstream surface of said absorbent pad.

5. The vacuum filtration apparatus of claim 4 wherein the thickness of said absorbent pad is substantially greater than the height of said pad well,
whereby the outer periphery of the absorbent pad is compressed by the filter means,
whereby said absorbent pad exerts an upward force on the downstream side of said filter means,
whereby said filter means remains in tension in both the dry and wet states,
whereby said filter means remains wrinkle free in both the dry and wet states.

6. The vacuum filtration apparatus of claim 1 wherein a portion of the filter means that is in contact with said filter seal surface, is sealed to said filter seal surface with a heat seal, said seal forming a closed loop.

7. The vacuum filtration apparatus of claim 1 wherein a portion of the filter means that is in contact with said filter seal surface, is sealed to said filter seal surface with an ultrasonic seal, said seal forming a closed loop.

8. The vacuum filtration apparatus of claim 1 wherein a portion of the filter means that is in contact with said filter seal surface, is sealed to said filter seal surface with a solvent seal, said seal forming a closed loop.

9. The vacuum filtration apparatus of claim 1 wherein said base contains one or more lid clamp tabs protruding from the outside wall of said base, with the bottom edge of each lid clamp tab of said base being equidistant from the top outer wall of said base.

10. The vacuum filtration apparatus of claim 9 wherein said funnel contains one or more lid clamp tabs protruding from the outside wall of said funnel, with the bottom edge of each lid clamp tab of said funnel being equidistant from the top wall of said funnel, and with the outside diameter of the lid clamp tabs of said funnel being equal to the outside diameter of the lid clamp tabs of said base.

11. The vacuum filtration apparatus of claim 10 wherein said vacuum filtration apparatus contains a lid, with the outer wall of said lid being segmented by a plurality of slots in said outer wall, with each slot creating a gap in the bottom surface of said outer wall,
with the height of said slots being less than the height of the inner surface of said outer wall of said lid,
with the height of the inner surface of said outer wall of said lid being equal to or greater than the distance between the bottom edge of each lid clamp tab of said funnel and the top wall of said funnel, and with the height of inner surface of said outer wall of said lid being equal to or greater than the distance between the bottom edge of each lid clamp tab of said base and the top outer wall of said base,
with the diameter of said inner surface of said outer wall of said lid being less than the outside diameter of the lid clamp tabs of said base,
whereby said plurality of slots in said outer wall of said lid allows said outer wall of said lid to flex,
whereby said flexing of said outer wall of said lid allows said lid to be releasably attached to the one or more lid clamp tabs of said funnel with a fit that prevents said lid from accidentally disengaging from said funnel, and allows said lid to be removed from said funnel with one hand, as the outside diameter of the lid clamp tabs of said funnel vary over the normal production range of dimensional tolerances, and as the inside diameter of said inner surface of said outer wall of said lid vary over the normal production range of dimensional tolerances,
whereby said flexing of said outer wall of said lid allows said lid to be releasably attached to the one or more lid clamp tabs of said base with a fit that prevents said lid from accidentally disengaging from said base, and allows said lid to be removed from said base with one hand, as the outside diameter of the lid clamp tabs of said base vary over the normal production range of dimensional tolerances, and as the inside diameter of said inner surface of said outer wall of said lid vary over the normal production range of dimensional tolerances.

12. The vacuum filtration apparatus of claim 2 wherein the top surface of the filter support means is disposed below said filter seal surface, thereby creating a pad well below said filter seal surface.

13. The vacuum filtration apparatus of claim 12 wherein an absorbent pad is disposed in said pad well, with the downstream surface of said absorbent pad resting on the top surface of said filter support means, and with a portion of the downstream surface of said filter means resting on the upstream surface of said absorbent pad.

14. The vacuum filtration apparatus of claim 13 wherein the thickness of said absorbent pad is substantially greater than the height of said pad well,
whereby the outer periphery of the absorbent pad is compressed by the filter means,
whereby said absorbent pad exerts an upward force on the downstream side of said filter means,
whereby said filter means remains in tension in both the dry and wet states,
whereby said filter means remains wrinkle free in both the dry and wet states.

15. The vacuum filtration apparatus of claim 14 wherein said base contains one or more lid clamp tabs protruding from the outside wall of said base, with the bottom edge of each lid clamp tab of said base being equidistant from the top outer wall of said base.

16. The vacuum filtration apparatus of claim 15 wherein said funnel contains one or more lid clamp tabs protruding from the outside wall of said funnel, with the bottom edge of each lid clamp tab of said funnel being equidistant from the top wall of said funnel, and with the outside diameter of the lid clamp tabs of said funnel being equal to the outside diameter of the lid clamp tabs of said base.

17. The vacuum filtration apparatus of claim 16 wherein said vacuum filtration apparatus contains a lid, with the outer wall of said lid being segmented by a plurality of slots in said outer wall, with each slot creating a gap in the bottom surface of said outer wall,
with the height of said slots being less than the height of the inner surface of said outer wall of said lid, and
with the height of the inner surface of said outer wall of said lid being equal to or greater than the distance between the bottom edge of each lid clamp tab of said funnel and the top wall of said funnel, and with the height of inner surface of said outer wall of said lid being equal to or greater than the distance between the bottom edge of each lid clamp tab of said base and the top outer wall of said base,
with the diameter of said inner surface of said outer wall of said lid being less than the outside diameter of the lid clamp tabs of said base,
whereby said plurality of slots in said outer wall of said lid allows said outer wall of said lid to flex,
whereby said flexing of said outer wall of said lid allows said lid to be releasably attached to the one or more lid clamp tabs of said funnel with a fit that prevents said lid from accidentally disengaging from said funnel, and allows said lid to be removed from said funnel with one hand, as the outside diameter of the lid clamp tabs of said funnel vary over the normal production range of dimensional tolerances, and as the inside diameter of said inner surface of said outer wall of said lid vary over the normal production range of dimensional tolerances,
whereby said flexing of said outer wall of said lid allows said lid to be releasably attached to the one or more lid clamp tabs of said base with a fit that prevents said lid from accidentally disengaging from said base, and allows said lid to be removed from said base with one hand, as the outside diameter of the lid clamp tabs of said base vary over the normal production range of dimensional tolerances, and as the inside diameter of said inner surface of said outer wall of said lid vary over the normal production range of dimensional tolerances.

18. The vacuum filtration apparatus of claim 17 wherein a portion of the filter means that is in contact with said filter seal surface, is sealed to said filter seal surface with a heat seal, said seal forming a closed loop.

19. The vacuum filtration apparatus of claim 17 wherein a portion of the filter means that is in contact with said filter seal surface, is sealed to said filter seal surface with an ultrasonic seal, said seal forming a closed loop.

20. The vacuum filtration apparatus of claim 17 wherein a portion of the filter means that is in contact with said filter seal surface, is sealed to said filter seal surface with a solvent seal, said seal forming a closed loop.

21. The vacuum filtration apparatus of claim 17 wherein said vacuum filtration apparatus is disposable.

22. A vacuum filtration apparatus comprising:
a base containing a funnel well with a filter seal surface disposed adjacent to the bottom of the inside wall of said funnel well, with a filter support means disposed in the bottom of said funnel well inside of said filter seal surface, with an outlet port disposed below said filter support means, said outlet port being in fluid flow communication with said filter support means,
a funnel with an open top, with the bottom outside portion of said funnel releasably attached to the inside wall of said funnel well of said base, where the releasable attachment between said funnel and said base is an interference fit between the outer edge of one or more integral flexible funnel seal rings protruding from the bottom outer periphery of said funnel, and the inside wall of said funnel well of said base,
a filter means disposed in the bottom portion of said funnel well with the downstream surface of said filter means lying in the same plane as said filter seal surface, said filter means releasably sealed between said filter seal surface of said base and the bottom surface of said of said funnel,
whereby said one or more integral flexible funnel seal rings provide a releasable attachment between said funnel and said base, over the normal production range of dimensional tolerances of said interior side wall of said funnel well, and over the normal production range of dimensional tolerances of the outer edge of said one or more integral flexible funnel seal rings,
whereby the integral flexible funnel seal rings of said funnel allow the funnel to be seated in said funnel well of said base so as to provide a leak tight seal between said filter seal surface of said base and the bottom surface of said of said funnel over the normal production range of dimensional tolerances of said interior side wall of said funnel well of said base, and over the normal production range of dimensional tolerances of the outer edge of said one or more integral flexible funnel seal rings of said funnel.

23. The vacuum filtration apparatus of claim 22 wherein the top surface of the filter support means is disposed below said filter seal surface, thereby creating a pad well below said filter seal surface.

24. The vacuum filtration apparatus of claim 23 wherein an absorbent pad is disposed in said pad well, with the downstream surface of said absorbent pad resting on the top surface of said filter support means, and with a portion of the downstream surface of said filter means resting on the upstream surface of said absorbent pad.

25. The vacuum filtration apparatus of claim 24 wherein the thickness of said absorbent pad is substantially greater than the height of said pad well,
whereby the outer periphery of the absorbent pad is compressed by the filter means,
whereby said absorbent pad exerts an upward force on the downstream side of said filter means,
whereby said filter means remains in tension in both the dry and wet states,
whereby said filter means remains wrinkle free in both the dry and wet states.

26. The vacuum filtration apparatus of claim 22 wherein a portion of the filter means that is in contact with said filter seal surface, is sealed to said filter seal surface with a heat seal, said seal forming a closed loop.

27. The vacuum filtration apparatus of claim 22 wherein a portion of the filter means that is in contact with said filter seal surface, is sealed to said filter seal surface with an ultrasonic seal, said seal forming a closed loop.

28. The vacuum filtration apparatus of claim 22 wherein a portion of the filter means that is in contact with said filter seal surface, is sealed to said filter seal surface with a solvent seal, said seal forming a closed loop.

29. The vacuum filtration apparatus of claim 22 wherein said base contains one or more lid clamp tabs protruding from the outside wall of said base, with the bottom edge of each lid clamp tab of said base being equidistant from the top outer wall of said base.

30. The vacuum filtration apparatus of claim 29 wherein said funnel contains one or more lid clamp tabs protruding from the outside wall of said funnel, with the bottom edge of each lid clamp tab of said funnel being equidistant from the top wall of said funnel, and with the outside diameter of the lid clamp tabs of said funnel being equal to the outside diameter of the lid clamp tabs of said base.

31. The vacuum filtration apparatus of claim 30 wherein said vacuum filtration apparatus contains a lid, with the outer wall of said lid being segmented by a plurality of slots in said outer wall, with each slot creating a gap in the bottom surface of said outer wall,
with the height of said slots being less than the height of the inner surface of said outer wall of said lid,
with the height of the inner surface of said outer wall of said lid being equal to or greater than the distance between the bottom edge of each lid clamp tab of said funnel and the top wall of said funnel, and with the height of inner surface of said outer wall of said lid being equal to or greater than the distance between the bottom edge of each lid clamp tab of said base and the top outer wall of said base,
with the diameter of said inner surface of said outer wall of said lid being less than the outside diameter of the lid clamp tabs of said base,
whereby said plurality of slots in said outer wall of said lid allows said outer wall of said lid to flex,
whereby said flexing of said outer wall of said lid allows said lid to be releasably attached to the one or more lid clamp tabs of said funnel with a fit that prevents said lid from accidentally disengaging from said funnel, and allows said lid to be removed from said funnel with one hand, as the outside diameter of the lid clamp tabs of said funnel vary over the normal production range of dimensional tolerances, and as the inside diameter of said inner surface of said outer wall of said lid vary over the normal production range of dimensional tolerances,
whereby said flexing of said outer wall of said lid allows said lid to be releasably attached to the one or more lid clamp tabs of said base with a fit that prevents said lid from accidentally disengaging from said base, and allows said lid to be removed from said base with one hand, as the outside diameter of the lid clamp tabs of said base vary over the normal production range of dimensional tolerances, and as the inside diameter of said inner surface of said outer wall of said lid vary over the normal production range of dimensional tolerances.

32. The vacuum filtration apparatus of claim 31 wherein a portion of the filter means that is in contact with said filter seal surface, is sealed to said filter seal surface with a heat seal, said seal forming a closed loop.

33. The vacuum filtration apparatus of claim 31 wherein a portion of the filter means that is in contact with said filter seal surface, is sealed to said filter seal surface with an ultrasonic seal, said seal forming a closed loop.

34. The vacuum filtration apparatus of claim 31 wherein a portion of the filter means that is in contact with said filter seal surface, is sealed to said filter seal surface with a solvent seal, said seal forming a closed loop.

35. The vacuum filtration apparatus of claim 31 wherein said vacuum filtration apparatus is disposable.

36. A vacuum filtration apparatus comprising:
a base containing a funnel well with a filter seal surface disposed adjacent to the bottom of the inside wall of said funnel well, with a filter support means disposed in the bottom of said funnel well inside of said filter seal surface, with the top surface of the filter support means disposed below said filter seal surface, thereby creating a pad well below said filter seal surface, with an outlet port disposed below said filter support means, said outlet port being in fluid flow communication with said filter support means,
a funnel with an open top, with the bottom outside portion of said funnel releasably attached to the inside wall of said funnel well of said base, where the releasable attachment between said funnel and said base is an interference fit between the outer wall of said funnel, and the inside wall of said funnel well of said base,
a filter means disposed in the bottom portion of said funnel well with the downstream surface of said filter means lying in the same plane as said filter seal surface, said filter means releasably sealed between said filter seal surface of said base and the bottom surface of said of said funnel,
an absorbent pad disposed in said pad well, with the downstream surface of said absorbent pad resting on the top surface of said filter support means, and with a portion of the downstream surface of said filter means resting on the upstream surface of said absorbent pad, with the thickness of said absorbent pad being substantially greater than the height of said pad well,
whereby the outer periphery of the absorbent pad is compressed by the filter means,
whereby said absorbent pad exerts an upward force on the downstream side of said filter means,
whereby said filter means remains in tension in both the dry and wet states,
whereby said filter means remains wrinkle free in both the dry and wet states.

37. The vacuum filtration apparatus of claim 36 wherein said base contains one or more lid clamp tabs protruding from the outside wall of said base, with the bottom edge of each lid clamp tab of said base being equidistant from the top outer wall of said base.

38. The vacuum filtration apparatus of claim 37 wherein said funnel contains one or more lid clamp tabs protruding from the outside wall of said funnel, with the bottom edge of each lid clamp tab of said funnel being equidistant from the top wall of said funnel, and with the outside diameter of the lid clamp tabs of said funnel being equal to the outside diameter of the lid clamp tabs of said base.

39. The vacuum filtration apparatus of claim 38 wherein said vacuum filtration apparatus contains a lid, with the outer wall of said lid being segmented by a plurality of slots in said outer wall, with each slot creating a gap in the bottom surface of said outer wall,
with the height of said slots being less than the height of the inner surface of said outer wall of said lid,
with the height of the inner surface of said outer wall of said lid being equal to or greater than the distance between the bottom edge of each lid clamp tab of said funnel and the top wall of said funnel, and with the height of inner surface of said outer wall of said lid being equal to or greater than the distance between the bottom edge of each lid clamp tab of said base and the top outer wall of said base,
with the diameter of said inner surface of said outer wall of said lid being less than the outside diameter of the lid clamp tabs of said base,
whereby said plurality of slots in said outer wall of said lid allows said outer wall of said lid to flex,
whereby said flexing of said outer wall of said lid allows said lid to be releasably attached to the one or more lid clamp tabs of said funnel with a fit that prevents said lid from accidentally disengaging from said funnel, and allows said lid to be removed from said funnel with one hand, as the outside diameter of the lid clamp tabs of said funnel vary over the normal production range of dimensional tolerances, and as the inside diameter of said inner surface of said outer wall of said lid vary over the normal production range of dimensional tolerances,
whereby said flexing of said outer wall of said lid allows said lid to be releasably attached to the one or more lid clamp tabs of said base with a fit that prevents said lid from accidentally disengaging from said base, and allows said lid to be removed from said base with one hand, as the outside diameter of the lid clamp tabs of said base vary over the normal production range of dimensional tolerances, and as the inside diameter of said inner surface of said outer wall of said lid vary over the normal production range of dimensional tolerances.

40. The vacuum filtration apparatus of claim 39 wherein a portion of the filter means that is in contact with said filter seal surface, is sealed to said filter seal surface with a heat seal, said seal forming a closed loop.

41. The vacuum filtration apparatus of claim 39 wherein a portion of the filter means that is in contact with said filter seal surface, is sealed to said filter seal surface with an ultrasonic seal, said seal forming a closed loop.

42. The vacuum filtration apparatus of claim 39 wherein a portion of the filter means that is in contact with said filter seal surface, is sealed to said filter seal surface with a solvent seal, said seal forming a closed loop.

43. The vacuum filtration apparatus of claim 39 wherein said vacuum filtration apparatus is disposable.

44. A vacuum filtration apparatus comprising:
a base containing a funnel well with a filter seal surface disposed adjacent to the bottom of the inside wall of said funnel well, with a filter support means disposed in the bottom of said funnel well inside of said filter seal surface, with the top surface of the filter support means disposed below said filter seal surface, thereby creating a pad well below said filter seal surface, with an outlet port disposed below said filter support means, said outlet port being in fluid flow communication with said filter support means, with said base containing one or more lid clamp tabs protruding from the outside wall of said base, with the bottom edge of each lid clamp tab of said base being equidistant from the top outer wall of said base,
a funnel with an open top, with the bottom outside portion of said funnel releasably attached to the inside wall of said funnel well of said base, where the releasable attachment between said funnel and said base is an interference fit between the outer wall of said funnel, and the inside wall of said funnel well of said base, said funnel containing one or more lid clamp tabs protruding from the outside wall of said funnel, with the bottom edge of each lid clamp tab of said funnel being equidistant from the top wall of said funnel, and with the outside diameter of the lid clamp tabs of said funnel being equal to the outside diameter of the lid clamp tabs of said base,
a filter means disposed in the bottom portion of said funnel well with the downstream surface of said filter means lying in the same plane as said filter seal surface, said filter means releasably sealed between said filter seal surface of said base and the bottom surface of said of said funnel,
an absorbent pad disposed in said pad well, with the downstream surface of said absorbent pad resting on the top surface of said filter support means, and with a portion of the downstream surface of said filter means resting on the upstream surface of said absorbent pad,
a lid, with the outer wall of said lid being segmented by a plurality of slots in said outer wall, with each slot creating a gap in the bottom surface of said outer wall,
with the height of said slots being less than the height of the inner surface of said outer wall of said lid,
with the height of the inner surface of said outer wall of said lid being equal to or greater than the distance between the bottom edge of each lid clamp tab of said funnel and the top wall of said funnel, and with the height of inner surface of said outer wall of said lid being equal to or greater than the distance between the bottom edge of each lid clamp tab of said base and the top outer wall of said base,
with the diameter of said inner surface of said outer wall of said lid being less than the outside diameter of the lid clamp tabs of said base,
whereby said plurality of slots in said outer wall of said lid allows said outer wall of said lid to flex,
whereby said flexing of said outer wall of said lid allows said lid to be releasably attached to the one or more lid clamp tabs of said funnel with a fit that prevents said lid from accidentally disengaging from said funnel, and allows said lid to be removed from said funnel with one hand, as the outside diameter of the lid clamp tabs of said funnel vary over the normal production range of dimensional tolerances, and as the inside diameter of said inner surface of said outer wall of said lid vary over the normal production range of dimensional tolerances,
whereby said flexing of said outer wall of said lid allows said lid to be releasably attached to the one or more lid clamp tabs of said base with a fit that prevents said lid from accidentally disengaging from said base, and allows said lid to be removed from said base with one hand, as the outside diameter of the lid clamp tabs of said base vary over the normal production range of dimensional tolerances, and as the inside diameter of said inner surface of said outer wall of said lid vary over the normal production range of dimensional tolerances.

45. The vacuum filtration apparatus of claim 44 wherein a portion of the filter means that is in contact with said filter seal surface, is sealed to said filter seal surface with a heat seal, said seal forming a closed loop.

46. The vacuum filtration apparatus of claim 44 wherein a portion of the filter means that is in contact with said filter seal surface, is sealed to said filter seal surface with an ultrasonic seal, said seal forming a closed loop.

47. The vacuum filtration apparatus of claim 44 wherein a portion of the filter means that is in contact with said filter seal surface, is sealed to said filter seal surface with a solvent seal, said seal forming a closed loop.

48. The vacuum filtration apparatus of claim 44 wherein said vacuum filtration apparatus is disposable.

49. A vacuum filtration apparatus comprising:
a base containing a funnel well with a filter seal surface disposed adjacent to the bottom of the inside wall of said funnel well, with a filter support means disposed in the bottom of said funnel well inside of said filter seal surface, with an outlet port disposed below said filter support means, said outlet port being in fluid flow communication with said filter support means,
a funnel with an open top, with the bottom outside portion of said funnel releasably attached to the inside wall of said funnel well of said base,
a filter seal ring press fitted into said funnel well of said base with an interference fit between the end surface of said filter seal ring and the inside wall of said funnel well,
a filter means disposed in the bottom portion of said funnel well with the downstream surface of said filter means lying in the same plane as said filter seal surface, said filter means sealed with a compression seal between the filter seal surface of said filter seal ring, and the filter seal surface of said base.

50. The vacuum filtration apparatus of claim 49 wherein the releasable attachment between said funnel and said base is an interference fit between the outer wall of said funnel, and the inside wall of said funnel well of said base.

51. The vacuum filtration apparatus of claim 49 wherein the releasable attachment between said funnel and said base is an interference fit between one or more integral flexible funnel seal rings protruding from the bottom outer periphery of said funnel, and the inside wall of said funnel well of said base,
whereby said one or more integral flexible funnel seal rings provide a releasable attachment between said funnel and said base, over the normal production range of dimensional tolerances of said interior side wall of said funnel well of said base, and over the normal production range of dimensional tolerances of the outer edge of said one or more integral flexible funnel seal rings of said funnel.

52. The vacuum filtration apparatus of claim 51 wherein the top surface of the filter support means is disposed below said filter seal surface, thereby creating a pad well below said filter seal surface.

53. The vacuum filtration apparatus of claim 52 wherein an absorbent pad is disposed in said pad well, with the downstream surface of said absorbent pad resting on the top surface of said filter support means, and with a portion of the downstream surface of said filter means resting on the upstream surface of said absorbent pad.

54. The vacuum filtration apparatus of claim 53 wherein the thickness of said absorbent pad is substantially greater than the height of said pad well,
whereby the outer periphery of the absorbent pad is compressed by the filter means,
whereby said absorbent pad exerts an upward force on the downstream side of said filter means,
whereby said filter means remains in tension in both the dry and wet states,
whereby said filter means remains wrinkle free in both the dry and wet states.

55. A vacuum filtration apparatus comprising:
a base containing a funnel well with a filter seal surface disposed adjacent to the bottom of the inside wall of said funnel well, with a filter support means disposed in the bottom of said funnel well inside of said filter seal surface, with said filter support means containing a seal surface at its outer periphery, with the top surface of the filter support means disposed below said filter seal surface, thereby creating a pad well below said filter seal surface, with an outlet port disposed below said filter support means, said outlet port being in fluid flow communication with said filter support means,
a funnel with an open top, with the bottom outside portion of said funnel releasably attached to the inside wall of said funnel well of said base,
a lower filter means disposed in the bottom of said pad well,
an absorbent pad disposed in said pad well above said lower filter means, with the downstream surface of said absorbent pad resting on the upstream surface of said lower filter means, with the outer periphery of said lower filter means sealed between said seal surface of said filter support means and the outer periphery of the downstream surface of said absorbent pad,
a filter means disposed in the bottom portion of said funnel well with the downstream surface of said filter means lying in the same plane as said filter seal surface of said base, said filter means releasably sealed between said filter seal surface of said base and the bottom surface of said of said funnel.

56. The vacuum filtration apparatus of claim 54 wherein the releasable attachment between said funnel and said base is an interference fit between the outer wall of said funnel, and the inside wall of said funnel well of said base.

57. The vacuum filtration apparatus of claim 54 wherein said filter seal surface of said base contains a groove in at least a portion of its outer periphery.
